(19) United States
(12) Patent Application Publication
(10) Pub. No.: US 2026/0318723 A1
(43) Pub. Date: Oct. 15, 2026

(54) Wide-Range Variable Venturi Multi-Phase Flowmeter Valve

(71) Applicant: Christopher Joseph Brown, Goleta, CA (US)

(72) Inventor: Christopher Joseph Brown, Goleta, CA (US)

(21) Appl. No.: 19/466,251

(22) Filed: Jan. 30, 2026

Related U.S. Application Data
(60) Provisional application No. 63/753,370, filed on Feb. 3, 2025.

(51) Int. Cl. G01F 1/40; F16K 15/06; F16K 37/00; G01F 25/10; G01N 9/32

(52) U.S. Cl. CPC G01F 1/40; F16K 15/065; F16K 37/0083; F16K 37/0091; G01F 25/10; G01N 9/32

(57) ABSTRACT

Systems and methods may include a flowmeter including a valve defining a fluid flow path including an inlet portion and an outlet portion to receive the fluid mixture, where the inlet portion has a spatially-varying cross-sectional diameter and cross-sectional shape. The valve includes a valve seat defining an opening between the inlet portion to the outlet portion. The valve includes a check disk biased against the valve seat and configured to move in response to the fluid mixture. The flowmeter includes sensors configured to determine position data, pressure data, and other data related to the fluid mixture, and circuitry coupled to the plurality of sensors to determine flow data including gas flow, oil flow, and liquid flow data associated with a flow of the fluid mixture based on check disk position data and the fluid density and to communicate the flow data to the monitoring system.

### CROSS-REFERENCE TO RELATED APPLICATION(S)

This application is a non-provisional of and claims priority to U.S. Provisional Patent Application No. 63/753,370 filed on Feb. 3, 2025 and entitled “Wide-Range Variable Venturi Multi-Phase Flowmeter Valve,” which is incorporated herein by reference in its entirety.

### FIELD

The present disclosure is generally related to valves, and more particularly to a variable Venturi flowmeter configured to measure multiple phases of mixed-fluid flows including gas and liquid over a wide range of flow rates.

### BACKGROUND

Venturi flowmeters have long been known for measuring fluid flow through a conduit. The Venturi flowmeter typically includes a narrow section (sometimes referred to a “throat” or constriction), which constricts or throttles fluid flow creating a pressure difference between the fluid pressures on either side of the narrow section. The Venturi flowmeter may cause a pressure increase on a first side and a pressure decrease on a second side, and the pressure difference can be used to calculate a flow rate of the fluid through the flowmeter.

For a given installation, the Venturi flowmeter may be selected based on an expected fluid flow volume and based on an expected narrow range of flow rates. The Venturi flowmeter may have a constriction with a cross-sectional dimension, which may be selected to ensure that the Venturi flowmeter is narrow enough to impede the fluid flow across the range of flow rates and volumes. If the fluid flow volume decreases to a level where the constriction does not impede the fluid flow, the Venturi flowmeter may be unable to measure the fluid flow.

Conventionally, Venturi flowmeters are designed with smooth transitions between the first conduit, the narrowing restriction, and the second conduit. The smooth transitions may minimize fluid flow turbulence, which could adversely impact the accuracy of the pressure measurements and thus the flow rate determination. In general, the fluid flow rate may be determined using Bernoulli's principles of fluid dynamics (developed by Daniel Bernoulli, a Swiss mathematician and physicist, who lived from 1700-1782), at least in part, based on a pair of pressure measurements taken, for example, at an inlet and an outlet of the Venturi flowmeter or at the narrow section and at one or more of the inlet or the outlet of the Venturi flowmeter.

The Bernoulli equations rely on an assumption that fluid flow parameters, such as velocity and density, remain constant at any point in time, that the fluid density does not change significantly with pressure variations, and that friction forces within the fluid are minimal. For variable velocity fluid flows having wide pressure variations, variable or changing fluid flow densities (e.g., fluid mixtures that include incompressible fluids, incompressible solids, and entrained compressible gases), and conduits with abrupt changes in direction and elevation, a conventional Venturi flowmeter may not produce consistently accurate pressure measurements and, as a result, fluid flow rate measurements may be difficult to obtain directly from the mixed-fluid flow.

### SUMMARY

Embodiments of variable-Venturi multi-phase flowmeters are described below that may be configured to determine one or more flow rates associated with a fluid mixture having one or more time-varying parameters, without recalibration. The time-varying parameters may include a time-varying flow rate, time-varying pressure, a time-varying fluid flow density, a time-varying fluid volume, or any combination thereof. The variable-Venturi, multi-phase flowmeter may be configured to receive a fluid mixture that may be composed of components having different densities and different material properties. The components may include compressible components, such as an entrained gas, and one or more incompressible components, such as water, oil, debris, chemicals, other components, or any combination thereof.

In one or more embodiments, the variable-Venturi multi-phase flowmeter coupled between a first conduit and a second conduit may be implemented as a check valve that includes a check disk. The check disk may be configured to move in response to fluid pressure to allow a fluid mixture to flow from the first conduit through the valve to the second conduit and to prevent fluid flow from the second conduit to the first conduit. In one or more embodiments, the check disk may be biased against a valve seat within the valve when a fluid pressure of the fluid mixture is below a threshold pressure. In this state, the check valve is closed to prevent fluid flow through the check valve, and more particularly, to prevent fluid from flowing from the second conduit through the check valve to the first conduit, which may be connected to a fluid source (such as an oil well).

In response to fluid pressure that exceeds a threshold pressure, the check disk may move away from the valve seat, increasing the effective cross-sectional dimension of the constriction from approximately zero to a displacement height and allowing the fluid mixture to pass through the valve. As the fluid pressure decreases, the check valve may move toward the valve seat, reducing the effective cross-sectional dimension of the constriction until the check disk contacts the valve seat. The check disk may close the valve, preventing fluid flow, when the fluid pressure falls below the threshold pressure.

In one or more embodiments, the check valve may include a sensor housing including one or more sensors configured to monitor position information related to the position of the check disk and a processor may be configured to determine one or more parameters correlated to the fluid flow rates of the components of the fluid mixture based, at least in part, on the position information. In response to receiving the fluid mixture, in one or more embodiments, a processor within the sensor housing of the variable-Venturi, multi-phase flowmeter may be configured to determine fluid flow data corresponding to multiple phases of the fluid mixture that is flowing through the valve based at least in part on the position of the check disk relative to the valve seat. In one or more embodiments, the fluid flow data may include a volume of gas, one or more volumes associated with one or more liquids of the fluid mixture, a volume associated with debris within the fluid mixture, cut data (such as the cut of oil and water or other liquid components of the fluid mixture), other data related to the fluid mixture, or any combination thereof. In one or more embodiments, the processor may be configured to infer a cut of oil within the fluid mixture based on changes in the electrical signals received from one or more of the position sensors.

In one or more embodiments, systems and methods may include a monitoring system to receive check disk position data, dielectric data, temperature data, flow rate data, other data, or any combination thereof from one or more flowmeters. Each flowmeter may include a valve defining a fluid flow path including an inlet portion to receive the fluid mixture from a first conduit and an outlet portion to provide the fluid mixture to a second conduit. In one or more embodiments, the valve may include a valve seat defining an opening between the inlet portion and the outlet portion. The valve may include a check disk that may be biased against the valve seat. The check disk may be configured to move in response to the fluid mixture.

The flowmeter may include a sensor housing coupled to the valve and including a plurality of sensors. The sensors may include at least one sensor configured to determine position data corresponding to a position of the check disk relative to the valve seat, a pressure sensor configured to determine a pressure of the fluid mixture within the sensor housing, a temperature sensor configured to determine a temperature of the fluid mixture within the sensor housing. The flowmeter may include circuitry coupled to the plurality of sensors and configured to determine a fluid density based on the temperature and the pressure and fluid flow data for multiple phases of the fluid mixture based on the position data. In one or more embodiments, the circuitry may be configured to determine gas flow data, oil flow data, liquid flow data, debris flow data, and other flow data associated with a flow of the fluid mixture across a wide and variable range of pressures, flow volumes, flow rates, compositions, densities, and so on. In one or more embodiments, the circuitry may be configured to communicate the flow data to a monitoring system through a communications network.

In one or more embodiments, a flowmeter includes a valve including an inlet, an inlet transition, an inlet chamber, a valve seat, an outlet chamber, an outlet transition, an outlet, a check disk, a piston, a plurality of sensors, and circuitry. The inlet may be configured to couple to a first conduit to receive a fluid mixture including one or more of water, oil, entrained gas, chemicals, or debris. The inlet may define a first portion of a fluid path that includes a first cross-sectional area and a first cross-sectional shape and that extends substantially horizontally. The inlet transition may be configured to couple to the inlet and may define a second portion of the fluid path that introduces a change from the substantially horizontal first portion. In one or more, the second portion of the fluid path may extend downward at an angle relative to the first path redirecting the fluid mixture. In one or more embodiments, in addition to or in lieu of changing a direction of the fluid flow, the second portion may include cross-sectional dimensions that may vary along its length from the first cross-sectional shape of the first portion to a second cross-sectional shape, from a first cross-sectional area to a second cross-sectional area that is greater than the first cross-sectional area, or both. The inlet chamber may be coupled to the inlet transition. In one or more embodiments, the inlet chamber may include an elongate shape, which may be different from or which may continue the second cross-sectional shape of the inlet transition. In one or more embodiments, the inlet transition may define a third cross-sectional area or may continue the second cross-sectional area. In one or more embodiments, the third cross-sectional area may be larger than the second cross-sectional area.

The valve seat may define an opening that is configured coupled to couple the inlet chamber to the outlet chamber. The valve seat may define a narrowing constriction between inlet chamber and the outlet chamber. In one or more embodiments, the valve seat may be formed by a circular ring formed from stainless steel or other corrosion and pressure resistant material, and the fluid mixture may flow through the opening in the valve seat.

The outlet chamber may be configured to receive the fluid mixture (including released, previously entrained gas) through the opening of the valve seat. In one or more embodiments, the outlet chamber may have a fourth cross-sectional area that may vary along its length. In one or more embodiments, the fourth cross-sectional area, a volume of the outlet chamber, or both may be greater than the third cross-sectional area, the volume of the inlet chamber, or both. The outlet chamber may be coupled to an outlet transition.

The outlet transition may be configured to couple the outlet chamber to the outlet, which may be coupled to a second conduit. In one or more embodiments, the outlet transition may have a spatially-variable cross-sectional area, shape, volume, or any combination thereof. In one or more embodiments, the outlet transition includes a cross-sectional area and shape that matches the outlet chamber at a first end and that matches the cross-sectional area and shape of the conduit at a second end.

In one or more embodiments, the check disk may be positioned within the outlet chamber and may be biased (by a spring and by gravity) against the valve seat. The check disk may be configured to move away from the valve seat in response to fluid pressure that exceeds a threshold defined by the weight of the valve and the spring constant of the spring. In one or more embodiments, movement of the check disk may vary in response to changes in fluid flow rate, fluid pressure, composition of the fluid mixture, or any combination thereof. In one or more embodiments, a piston may be coupled to and configured to move with the check disk. In one or more embodiments, the flowmeter may include a sensor housing including a plurality of sensors configured to determine position data associated with the check disk, a temperature sensor to determine a temperature of the fluid mixture within the sensor housing, and a pressure sensor to determine a pressure associated with the fluid mixture within the sensor housing. The circuitry may include a processor coupled to the plurality of sensors and configured to determine fluid density of the fluid mixture and to determine fluid flow data associated with multiple phases of the fluid mixture based on the position data and the fluid density.

In still other embodiments, a system may include a monitoring system and a flowmeter. The monitoring system may include a network interface configured to communicatively couple to a communications network, a processor coupled to the network interface, and a memory accessible to the processor and storing data and instructions. The instructions, when executed, may cause the processor to receive fluid flow data corresponding to a fluid mixture from a flowmeter via the communications network. The instructions may cause the processor to determine, based on the received data, first flow data corresponding to released gas, second flow data corresponding to a cut of oil, and third flow data corresponding to the flow of the fluid mixture, and communicate the first flow data, the second flow data, and the third flow data to at least one computing device via the communications network.

The flowmeter may include a valve defining a fluid flow path including an inlet portion and an outlet portion and configured to allow a fluid mixture to flow from the inlet portion to the outlet portion and to prevent flow from the outlet portion to the inlet portion. In one or more embodiments, the inlet portion may have a spatially varying cross-sectional diameter and spatially varying cross-sectional shape. The valve may include a valve seat including an opening configured to couple the inlet portion to the outlet portion and a check disk biased against the valve seat and configured to move in response to the fluid mixture. The flowmeter may include a sensor housing including a plurality of sensors including one or more position sensors including at least one position sensor configured to determine a position of the check disk relative to the valve seat. The sensors may include a pressure sensor configured to determine pressure data associated with the fluid mixture flowing into the sensor housing, and a temperature sensor configured to determine a temperature of the fluid mixture flowing into the sensor housing. The flowmeter may include a circuit housing including a processor coupled to the plurality of sensors and configured to determine multiple parameters associated with a flow of the fluid mixture based on the position data and the fluid density determined from the temperature and the pressure data. In one or more embodiments, the circuitry may include communication circuitry configured to communicate at least one of the multiple parameters, the pressure data, the temperature data, the position data, flow data for multiple phases of the fluid mixture, other data, or any combination thereof to the monitoring system.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 depicts a block diagram of a system including a multi-phase flowmeter, in accordance with certain embodiments.

FIG. 2 depicts a cross-sectional diagram of a multi-phase flowmeter device, such as the multi-phase flowmeter of FIG. 1, configured to determine fluid flow parameters associated with a fluid mixture with a check disk in a closed position, in accordance with certain embodiments.

FIG. 3 depicts a cross-sectional diagram of the multi-phase flowmeter of FIG. 2 with the check disk in an open position.

FIG. 4 depicts an expanded view of a valve portion of the multi-phase flowmeter of FIG. 2, in accordance with certain embodiments.

FIG. 5 depicts an expanded view of a valve portion of the multi-phase flowmeter of FIG. 3, in accordance with certain embodiments.

FIG. 6 depicts a cross-sectional isometric view of an embodiment of the multi-phase flowmeter of FIG. 2, including fluid windows to enable fluid flow through the sensor housing, in accordance with certain embodiments.

FIG. 7 depicts an exploded, top perspective view of components of the multi-phase flowmeter of FIGS. 1-6, in accordance with certain embodiments.

FIG. 8 depicts an exploded, bottom perspective view of components of the multi-phase flowmeter of FIGS. 1-6, in accordance with certain embodiments.

FIG. 9 depicts an expanded view of an embodiment of the check disk of the valve of any of FIGS. 1-8 relative to the valve seat, in accordance with certain embodiments.

FIG. 10 depicts a flow diagram of a method of determining multiple phases of a fluid mixture flowing through a valve, in accordance with certain embodiments.

While implementations are described in this disclosure by way of example, those skilled in the art will recognize that the implementations are not limited to the examples or figures described. The figures and detailed description thereto are not intended to limit implementations to the particular form disclosed, but on the contrary, the intention is to cover all modifications, equivalents, and alternatives falling within the spirit and scope as defined by the appended claims. The headings used in this disclosure are for organizational purposes only and are not meant to limit the scope of the description or the claims. As used throughout this application, the word “may” is used in a permissive sense (in other words, the term “may” is intended to mean “having the potential to”) instead of in a mandatory sense (as in “must”). Similarly, the terms “include”, “including”, and “includes” mean “including, but not limited to”.

### DETAILED DESCRIPTION OF ILLUSTRATIVE EMBODIMENTS

Embodiments of a multi-phase flowmeter are described below that may be configured to determine a flow rates and volumes of components of a fluid mixture, including entrained gas, oil, liquid, debris, or any combination thereof. In one or more embodiments, the fluid mixture may be a crude oil mixture that may include entrained gas, oil, water, chemicals, sand, other debris, or any combination thereof. The multi-phase flowmeter may include a valve defining a fluid flow path from an inlet to an outlet through a valve seat. The valve may include a check disk that may be biased toward the valve seat and that may move in response to the fluid pressure of the fluid mixture. The check disk may provide a check disk function in which the check disk moves away from a valve seat to allow the fluid mixture to flow from the inlet to the outlet and in which, in response to the fluid pressure falling below a pressure threshold, the check disk moves toward the valve seat to prevent the fluid mixture from flowing from the outlet to the inlet through the valve.

Within the flowmeter, the check disk performs a second function. It should be understood that the valve seat of the valve defines a narrowing constriction that is constant and that may produce a pressure differential between the inlet portion and the outlet portion of the valve when the fluid mixture has sufficient flow volume that the opening through the valve seat restricts the flow of the fluid mixture. At lower flow volumes, the position of the check disk relative to the valve seat may provide a variable constriction that enables a variable Venturi where the dimensions of the narrowing constriction vary over a wide range of flow volumes and fluid pressures. Unlike conventional Venturi valves that may operate over a narrow range of flow volumes and fluid pressures and that do not provide accurate fluid flow measurements with time-varying flow volumes (such as those present in crude oil production, such as fluid mixtures produced using a pump jack), the flowmeter may be configured to accurately measure fluid flow in such environments and across the entire range of the pump jack production cycle and for varying fluid densities and compositions.

In one or more embodiments, the valve seat and the check disk may provide a variable constriction (e.g., a variable cross-sectional area of the flow path) based on the flow volume of the fluid mixture, ensuring a pressure differential across the valve over a range of fluid pressures. However, unlike a conventional Venturi flowmeter in which the pressure differential is measured using pressure sensors on either side of the constriction, the multiphase flowmeter described herein may be configured to determine flow data of multiple phases of the fluid mixture based on position data corresponding to the displacement of the check disk relative to the valve seat. In one or more embodiments, the multi-phase flowmeter may be configured to determine a cut of oil versus water in the fluid mixture based on changing electrical signals of at least one of the position sensors. In some embodiments, the changing electrical signals may be caused by a change in a dielectric of a fluid mixture, which may be indicative of the composition of the fluid mixture and which may be used to calculate the composition of the fluid mixture. In some embodiments, the multi-phase flow meter may include one or more chemical sensors or cut sensors configured to determine a cut of the fluid mixture. In one or more embodiments, the multi-phase flowmeter may also utilize data determined from the one or more position sensors to determine a first volume of gas and one or more second volumes of the fluids flowing through the valve.

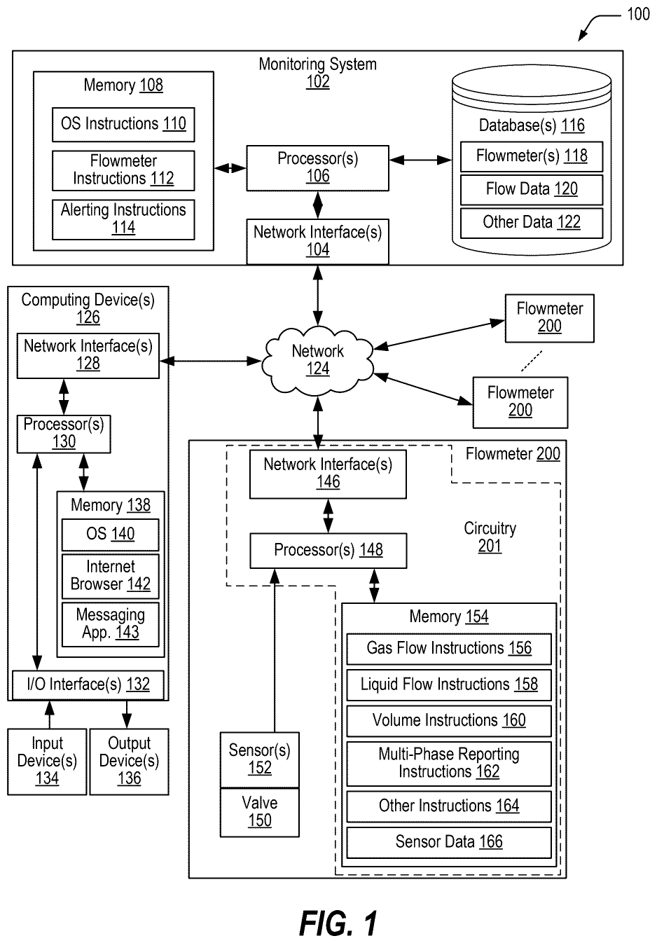

In one or more embodiments, the flowmeter may be configured to send sensor data via a communications network to a monitoring system, which may be a computing device or cloud-computing system that may be communicatively coupled to one or more flowmeters to calculate multi-phase parameters (flow characteristics) of the fluid mixture. In one or more embodiments, circuitry within the flowmeter may determine the multi-phase parameters (flow characteristics) and may communicate the determined multi-phase parameters to one or more of a control system or a computing device via a communications network. An example of a system including a multi-phase flowmeter is described below with respect to FIG. 1.

FIG. 1 depicts a block diagram of a system 100 including a multi-phase flowmeter 200, in accordance with certain embodiments. The system 100 may include a monitoring system 102 configured to communicate with one or more flowmeters 200 and with one or more computing devices 126 through a communications network 124. The communications network 124 may include a local area network (LAN), a wide-area network (WAN), a Wi-Fi network, the Internet, a cellular network, a satellite network, another type of network, or any combination thereof.

The monitoring system 102 may be configured to receive data from multiple flowmeters 200 and to store the data in one or more databases 116. The monitoring system 102 may include one or more network interfaces 104 configured to communicatively couple the monitoring system 102 to the communications network 124. The monitoring system 102 may include one or more processors 106 coupled to the one or more network interfaces 102. The one or more processors 106 may be configured to execute processor-readable instructions to perform various functions.

The monitoring system 102 may include a memory 108, which may include a non-volatile memory that may store processor-readable instructions and data. The memory 108 may be accessible to the one or more processors 106. The memory 108 may include operating system instructions 110 that may be executable by the one or more processors 106 to control operation of the monitoring system 102.

The memory 108 may include flowmeter instructions 112 that, when executed, may cause the processors 106 to receive data from the one or more flowmeters 200. The data may include timing information, sensor data, other data, or any combination thereof. In one or more embodiments, the flowmeter instructions 112 may cause the one or more processors 106 to correlate received data with one of the flowmeters 200 and determine flow data associated with a fluid mixture flowing through the flowmeter based on the data. The flowmeter instructions 112 may cause the one or more processors 106 to store the flow data 120 in a database 116, together with flowmeter data 118 and other data 122. In one or more embodiments, the database 116 may store identifying information about each flowmeter 200 in the flowmeter data 118 and may store associated flow data 120 and other data 122 in the database 116 such that the data is correlated and linked.

In one or more alternative embodiments, the flowmeters 200 may include circuitry configured to calculate the multi-phase flow data and may communicate the multi-phase flow data to the monitoring system 102. In such an embodiment, the flowmeter instructions 112 may cause the one or more processors 106 to receive the multi-phase flow data, to store the flow data 120 and other data 122 in one or more database records of the database 116 that are linked to a particular flowmeter within the flowmeter data 118.

The memory 108 may include alerting instructions 114 that, when executed, may cause the one or more processors 106 to generate an alert based on the flow data 120 or the other data. The alert may include an electronic message, such as a text message or an electronic mail message (“email”), an automated phone call, or another message. The alerting instructions 114 may cause the one or more processors 106 to generate the alert and to initiate transmission of the alert to one or more computing devices 126 via the communications network 124 or optionally to circuitry 201 of one or more of the flowmeters 200.

The one or more computing devices 126 may include one or more of a laptop computer, a smartphone, a tablet computer, or a desktop computer. Each computing device 126 may include one or more network interfaces 128 configured to communicatively couple the computing device 126 to the communications network 124. The computing device 126 may include one or more processors 130 configured to execute processor-readable instructions, which may be stored in a non-volatile memory 138.

The computing device 126 may include one or more input/output (I/O) interfaces 132, which may be coupled to the one or more processors 130. The I/O interfaces 132 may be coupled to one or more input devices 134 to receive data and to one or more output devices 136 to provide data. The input device 134 may include one or more of a keyboard, a touch-sensitive interface, a camera, a scanner, a microphone, or a pointer device (such as a mouse, a trackball, a track pad, or a stylus). The output device 136 may include a display, a speaker, a printer, or another output device. In one or more embodiments, an input device 134 and an output device 136 may be combined, such as in the form of a touchscreen display.

The memory 138 may store operating system instructions 140 that may be executed by the processor 130 to control operation of the computing device 126. The memory 138 may include an Internet browser application 142 that, when executed, may cause the processor 130 to generate a graphical interface that may be accessed by a user to access data stored by the monitoring system 102. The memory 138 may include one or more messaging applications 143, such as an email application, a text-message application (which may be configured to receive text data, image data, sound data, video data, or any combination thereof), another application configured to receive the alert from the monitoring system 102, or any combination thereof. In one or more embodiments, the messaging application 143 may be a proprietary or custom application configured to link a user to the monitoring system 102 and optionally to one or more flowmeters 200 to view flow data, to configure settings, to receive alerts, or any combination thereof.

Each of the flowmeters 200 may be configured to determine data that may be used to determine multiple phases of a fluid mixture received at a valve 150 of the flowmeter 200. The valve 150 may experience fluid flow mixtures having a wide range of pressures, flow rates, and composition densities, any of which may be time varying. The flowmeter 200 may include circuitry 201 including one or more network interfaces 146 configured to communicatively couple the flowmeter 200 to the communications network 124 to communicate data to one or more of the monitoring system 102 or a computing device 126. The one or more network interfaces 146 may include a wired connection (such as an Ethernet port, a controller area network (CAN) interface, or another wired connection interface), a wireless radio frequency (RF) signal communications interface (such as an IEEE 802.11x transceiver, a Wi-Fi transceiver, a cellular transceiver, a satellite transceiver, a short-range RF transceiver (e.g., Bluetooth, near-field communications, or another short-range RF communications device), another wireless communications interface, or any combination thereof. The circuitry 201 may include one or more processors 148 coupled to the network interfaces 146 and configured to execute processor-readable instructions. The circuitry 201 may be coupled to one or more sensors 152. The sensors 152 may include position sensors, a pressure sensor, a temperature sensor, magnetic sensors, radio frequency sensors, ultra-wideband radar sensors, other sensors, or any combination thereof. In one or more embodiments, the position sensors may be configured to determine position data associated with movement of a check disk of the valve 150 and a fluid path within a sensor housing associated with the valve 150.

The circuitry 201 may include a non-volatile memory 154, which may be coupled to the one or more processors 148 and which may be configured to store data and processor-readable instructions. The memory 154 may include gas flow instructions 156 that, when executed, may cause the processors 148 to determine movement data associated with a check disk of the valve 150 from the one or more sensors 152, determine frequency data associated with the movement data of the check disk, and infer data indicative of gas flow based on the frequency data. In one or more embodiments, the valve 150 may include a check disk that may be biased in a closed position and that may open in response to fluid pressure from the fluid mixture flowing through the valve 150. The gas flow instructions 156 may be configured to determine one or more gas flow parameters corresponding to one or more gases released from the fluid mixture and passing through the valve 150. The circuitry 201 may determine the gas flow parameters based on position data from the one or more sensors 152 that may be indicative of positions of the check disk over time, including the extent of the movement, the rate of change of the position of the check disk, frequency data, other data, or any combination thereof.

The memory 154 may include liquid flow instructions 158 that, when executed, may cause the processors 148 to determine position data associated with the position of the check disk of the valve 150 over time that corresponds to a volume of incompressible fluid flowing through the valve 150. In one or more embodiments, the position data may also be indicative of fluid pressure through a narrow constriction (throat, neck, or narrow portion that may be formed by a valve seat within the valve that may restrict fluid flow relative to at least one of cross-sectional area or volume a fluid flow path on at least one side of the narrow constriction within the valve housing). The fluid mixture may flow through the valve 150 by pushing the check disk away from the valve seat, and one or more of the sensors 152 may be configured to determine data indicative of a position of the check disk relative to the valve seat as the check disk moves in response to fluid mixture. The memory 154 may include volume instructions 160 that, when executed, may cause the processor 148 to determine a flow volume for one or more of multiple phases of the fluid flow based on the sensor data 152. In one or more embodiments, the volume instructions 160 may cause the processor 148 to determine the fluid density of the “incompressible” components of the fluid mixture based on a temperature and a pressure determined from the fluid mixture within the sensor housing, and may cause the processor 148 to determine flow data based on the position data and the fluid density.

The memory 154 may include multi-phase reporting instructions 162 that, when executed, may cause the processor 148 to communicate data related to at least one of the sensor data from the sensors 152, the gas flow data, the liquid flow data, the volume data, oil/water cut data, other data, or any combination thereof to the monitoring system 102. The multi-phase reporting instructions 162 may cause the processor 148 to communicate the data periodically, to stream the data in real time, to provide the data in response to a signal received from the monitoring system 102, or any combination thereof. The memory 154 may include other instructions 164, which may cause the processor 148 to perform other operations. The memory 154 may also be configured to store sensor data 166. In one or more embodiments, the sensor data 166 may include raw sensor measurement data, gas flow data, the liquid data, the cut data, other data, or any combination thereof.

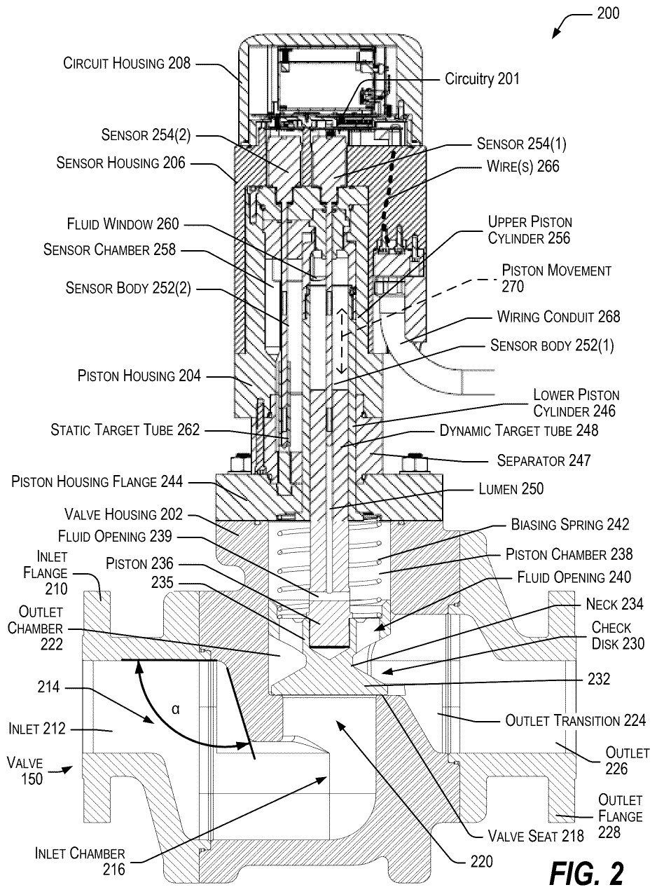

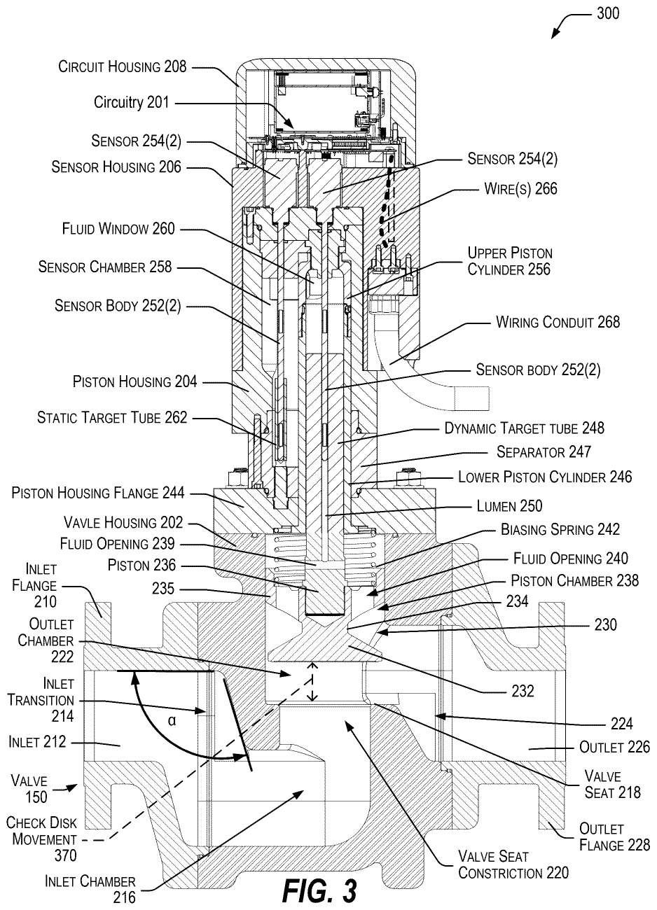

In the following discussion, FIGS. 2 and 3 depict a cross-sectional diagrams of the multi-phase flowmeter 200 of FIG. 1. As mentioned above, the multi-phase flowmeter 200 may be configured to determine multi-phase fluid flow parameters associated with a fluid mixture, in accordance with certain embodiments. In FIG. 2, the flowmeter 200 may include a valve 150 including a check disk 230 in a closed position, biased by a biasing spring 242 against a valve seat 228. In FIG. 3, the flowmeter 200 includes the check disk 230 in an open position, spaced apart from the valve seat 228. FIGS. 2 and 3 are discussed together below in connection with the opening and closing of the valve 150 by the check disk 230 in response to the fluid mixture flowing through the valve 150 from an inlet 212 to the outlet 226.

It should be appreciated that the one or more parameters of the fluid mixture may be time varying. For example, the parameters may include one or more of flow volume, flow rate, fluid pressure, fluid density, temperature, composition, other characteristics, or any combination thereof. In one or more embodiments, the fluid mixture may be a crude oil mixture that may include entrained gas, water, oil, chemicals, debris, or any combination thereof. The water, oil, chemicals, and debris may be incompressible, while the gas may be compressible. The composition of the fluid mixture may vary, the fluid pressure may vary, the volume may vary, the flow rate may vary, and so on. In an example, a pump jack may be configured to draw the fluid mixture from a well to the surface and through the valve 150 during an upstroke portion of the pump jack cycle and to reset during a downstroke portion of the cycle. The cycle may last from ten to thirty seconds (or any duration, shorter or longer, based on selected operational characteristics of the well), and the fluid pressure, the flow rate, the fluid density, the fluid composition, and the flow volume of the fluid mixture may vary across the pump jack cycle or over a longer period of time. For example, the fluid pressure may vary across the pump jack cycle from zero pounds per square inch (PSI) or a low range such as ten PSI or less to up to 850 PSI or more. The check disk 230 within the valve 150 may open (FIG. 3) and close (FIG. 2) during each cycle in response to pressure that is applied by the fluid mixture, allowing the fluid mixture to pass through and preventing the fluid mixture from flowing back into the well during the downstroke of the pump jack.

The flowmeter device 200 may include the valve 150 including a valve housing 202, a piston housing 204 coupled to the valve housing 202, a sensor housing 206 coupled to the piston housing 204, and a circuit housing 208 coupled to the sensor housing 206. The housings 202, 204, 206, and 208 may be coupled by bolts and may include seals, such as O-rings, gaskets, and other features to prevent components of the fluid mixture from escaping through the flowmeter 200.

The valve housing 202 may include an inlet flange 210 configured to couple to a corresponding flange (not shown) of a fluid conduit. The inlet flange 210 may include an opening or inlet 212 sized to match an interior diameter of the fluid conduit to receive a fluid mixture. As previously discussed, the fluid mixture may include one or more of oil, water, debris, chemicals, or entrained gas.

The inlet 212 may extend substantially horizontally (parallel to a central axis of the conduit from which it receives the fluid mixture. The valve housing 202 may define an inlet transition 214 extending between the inlet 212 and an inlet chamber 216. The inlet transition 214 may be configured to receive the flow of the fluid mixture from a substantially horizontal path and to redirect the fluid mixture at an angle α in a downward direction relative to the horizontal path. In one or more embodiments, the directional change introduced by the inlet transition 214 may cause turbulence in the flow of the fluid mixture, making the flow of the fluid mixture more chaotic.

In the illustrated example, the inlet transition 214 may also introduce a change to at least one dimension of the fluid flow path. In one or more embodiments, the dimension may include a cross-sectional shape, a cross-sectional area, a volume, or any combination thereof. In one or more embodiments, the inlet transition 214 may transition from a first cross-sectional shape at an end coupled to the inlet 212 to a second cross-sectional shape at an end coupled to the inlet chamber 216. In one or more embodiments, the cross-sectional shape, the cross-sectional area, or both may vary along the length of the inlet transition 214 between the inlet 212 and the inlet chamber 216. It should be understood that the cross-sectional area at any location along the length of the inlet transition 214 may be measured by a line extending between opposing interior surfaces of the inlet transition 214 at an angle that is substantially perpendicular to both surfaces.

In one or more embodiments, the inlet transition 214 may transition from a circular shape having a first cross-sectional area to a second shape having a second cross-sectional area. The second shape may be an elongate cross-sectional shape, such as an ellipse, a rounded-rectangle, or another shape. In one or more embodiments, the inlet transition 214 may have a circular cross-sectional shape at an end coupled to the inlet 212 and may transition to have an elliptical cross-sectional shape at an end coupled to the inlet chamber 216. In one or more embodiments, the elongate or major axis of the cross-section of the inlet transition 214 at the inlet chamber 216 may extend substantially vertically, while the minor axis may extend substantially horizontally. The second cross-sectional area of the end of the inlet transition 214 that is coupled to the inlet chamber 216 may be larger than the first cross-sectional area at an end of the inlet transition 214 that is coupled to the inlet 212.

In one or more embodiments, the inlet transition 214 may reduce the fluid pressure concurrently with redirection of the fluid mixture, which may introduce or exacerbate turbulence in the flow of the fluid mixture. The turbulence introduced by the redirection provided by the inlet transition 214 and the corresponding pressure drop provided by the expansion may cause or encourage at least a portion of the entrained gas to separate from the fluid mixture.

The inlet chamber 216 may be larger than the inlet 212 and may be larger than or at least equal to the largest cross-sectional area of the inlet transition 214. The inlet chamber 216 may be oriented vertically such that its longitudinal axis extends vertically toward a valve seat 218 and the corresponding opening 220. In one or more embodiments, the inlet chamber 216 may redirect the fluid mixture from the downward trajectory introduced by the inlet transition 214 to an upward (vertical) trajectory toward the valve seat 218 and the opening 220 through the valve seat 218.

The valve 150 may include an outlet chamber 222 on an opposite side of the valve seat 218 from the inlet chamber 216. The valve 150 may include an outlet transition 224, which may extend between the outlet chamber 222 and an outlet 226, which may be coupled to a second conduit (not shown). The outlet 226 may have the same interior shape and interior diameter as the interior diameter of the second conduit. The valve 150 may include an outlet flange 228 configured to couple to a corresponding flange of the second conduit. The outlet 226 may extend through the outlet flange 228 to deliver the fluid mixture to the second conduit.

In one or more embodiments, the outlet transition 224 may vary from a first shape having a first cross-sectional diameter corresponding to that of the outlet chamber 222 to a second shape having a second cross-sectional diameter that matches that of the outlet 226 coupled to the second conduit (not shown). In one or more embodiments, the outlet transition 224 may have a first cross-sectional area at a first end coupled to the outlet chamber 222 and a second cross-sectional area at a second end coupled to the outlet 226.

The valve 150 may include a check disk 230, including a check disk body 232 having a bottom surface including a portion configured to engage the valve seat 218. The check disk body 232 may include a narrow portion or neck 234 and an upper body portion 235 that includes a first opening to receive a piston 236 and that is sized to fit within a piston chamber 238. The upper body portion 235 may include fluid openings 240 configured to enable at least a portion of the fluid mixture to flow through the upper body portion 235 into the piston chamber 238. The valve 150 may include a biasing spring 242 configured to contact a bottom surface of the piston housing flange and the upper body portion 235 of the check disk 230 to bias the check disk 230 toward the valve seat 218.

The piston housing 204 may include a piston housing flange 244 configured to couple to the valve housing 202. The piston housing flange 244 may include an opening configured to align to the piston chamber 238 and sized to receive an upper portion of the piston 236. The piston housing 204 may include a lower piston cylinder 246 that extends into and lines opening within the piston housing 204, restricting lateral movement of the piston 236 and thereby preventing lateral movement of the check disk 230. In one or more embodiments, the piston housing 204 may include a separator 247 between the piston housing flange 244 and the rest of the piston housing 204. The separator 247 may include an opening to receive the piston 236 and the lower piston cylinder 246.

The piston 236 may include a lumen 250, which may be coupled to the piston chamber 238 by one or more fluid paths 239. The fluid paths 239 may couple the lumen 250 to the outlet chamber 222 of the piston 236. The lumen 250 may be sized to receive a sensor body 252(1) and the piston 236 may serve as the dynamic target tube 248.

The sensor body 252(1) and associated sensor 254(1) may be an embodiment of one of the one or more sensors 152 in FIG. 1. The lumen 250 may provide a dynamic target tube 248 for the sensor body 252(1), which may be configured to generate sensor data indicative of a position of the piston 236 relative to the sensor body 252(1). As the fluid mixture pushes the check disk 230, the piston 236 moves with the movement of the check disk 230, and the dynamic target tube 248 of the piston 236 moves relative to the sensor body 252(1), which produces an electric signal indicative of the position of the piston 236 relative to the sensor body 252(1). In one or more embodiments, the separator 247 may include a static target tube 262 that is fixed within the piston housing 204 and that is configured to receive a second sensor body 252(2) of an associated sensor 254(2). The second sensor body 252(2) may be configured to provide a second measurement (static sensor data) indicative of static position. The static sensor data from the second sensor body 252(2) may be used by circuitry 201 in the circuit housing 208 to account for temperature-based measurement variations and other measurement variations in measurement data from the first sensor body 252(1).

The piston housing 204 may include an upper piston cylinder 256, which may couple to an upper portion of the lower piston cylinder 246. The upper piston cylinder 256 may define a sensor chamber 258, which may extend around the sensor bodies 252(1) and 252(2). The sensor housing 206 may fit over and engage with an upper portion of the piston housing 204 to define the sensor chamber 258 and to fit over the sensors 254(1) and 254(2) from which the sensor bodies 252(1) and 252(2) extend, respectively. The upper piston cylinder 256 may include one or more fluid windows 260, which may provide a return path for fluid flow out from the lower and upper piston cylinders 254 and 256, around the second sensor body 252(2) and the static target tube 262, and back to the outlet chamber 222 of the valve 150 through the fluid openings 240 of the upper body portion 235 of the check disk 230.

The sensors 254(1) and 254(2) may be coupled to circuitry 201 within the circuit housing 208. The circuitry 201 may be coupled by wires 266 to one or more external devices, such as transceiver circuitry (configured to provide wired or radio frequency wireless communication), a monitoring system 102, other circuitry, or any combination thereof. The flowmeter 200 may include a wiring conduit 268 that may include a power supply connection as well as communication wiring, such as communication cabling (Ethernet, CAN, or other wired-communication cabling), a communications bus, or other electrically conductive wiring, which may be communicatively coupled to the wires 266.

In operation, the valve 150 may receive a fluid mixture at the inlet 212. The fluid mixture may include one or more of oil, water, debris, entrained gas, or chemicals. The fluid mixture may be delivered to the inlet 212 with time-varying flow characteristics, such as a time-varying flow volumes, time-varying pressures, time-varying fluid velocities, and so on. Additionally, the fluid mixture may vary in terms of its component densities as the volumes of one or more of oil, water, entrained gas, chemicals, or debris may vary over time. Since the entrained gas is compressible while the other components may be incompressible, at least one parameter (compressibility) of the fluid mixture may be time varying. Additionally, the variation in the composition of the fluid mixture may alter electrical or electromagnetic parameters (such as conductivity, permittivity, or other parameters) such that the parameters may also be time varying.

In one or more embodiments, the valve 150 may be used in connection with oil production or water production involving a reciprocating pump, such as a pump jack, to pump the fluid mixture from a well. The cycling periods of the reciprocating pump jack may provide the time-varying fluid flow characteristics that may vary with the pump cycle such that each pump cycle includes a first high-pressure portion that decays over time followed by a low-pressure portion during which a traveling piston pushes through the fluid downward into the well until it reaches the end of its stroke and begins its path upward again to pump more of the fluid mixture.

During the high-pressure and decaying portions of the pump's cycle, the fluid mixture may flow into the inlet 212, through the inlet transition 214, and into the inlet chamber 216. The fluid mixture may push against and move the check disk 230. When the pressure of the fluid mixture exceeds a threshold pressure applied by the check disk 230 (which is a combination of the spring force applied by the biasing spring 242, gravitational forces acting on the check disk 230, and friction forces (if any) between the upper body portion 235 and the piston chamber 238 and between the dynamic target tube 248 and the lower piston cylinder 246), the fluid mixture may push the check disk 230 away from the valve seat 218. As the check disk 230 moves away from the valve seat 218, the fluid mixture may flow from the inlet chamber 216, through the opening 220 of the valve seat 218 and into the outlet chamber 222 before flowing through the outlet transition 224 and through the outlet 226 to a second conduit (not shown).

As the check disk 230 moves, the piston 236 moves, causing the dynamic target tube 248 to move relative to the sensor body 252(1). A portion of the fluid mixture may flow through the fluid openings 240 and into the lumen 250 and around the dynamic target tube 248, thereby interacting with the sensor body 252(1), for example, by exposing the sensor body 252(1) to the temperature of the fluid mixture and to the fluid mixture itself. The fluid mixture may be pushed by the high pressure through the dynamic target tube 248 and through the one or more fluid windows 260, causing the fluid mixture to flow into and around the sensor body 252(2) and the static target tube 262 and back to the outlet chamber 222. In one or more embodiments, the fluid flow path through the piston housing 204, around the sensor bodies 252, through the fluid window 260 and back to the outlet chamber 222 prevents “hydrostatic lock.” Additionally, the fluid flow path enables temperature management across the sensor bodies 252 and enables detection of the dielectric of the fluid mixture.

The sensor body 252(1) may be used to determine a position of the check disk 230 relative to the valve seat 218. The position of the check disk 230 may be determined based on a position along the sensor body 252(1) where an electrical characteristic changes abruptly, indicating an edge of the dynamic target tube 248 relative to the sensor body 252(1), which is measurably different from the electrical characteristics of the sensor body 252(1) relative to the lower piston cylinder 246 and the upper piston cylinder 256, independent of changes in the dielectric of the fluid mixture. However, changes in the dielectric of the fluid mixture may also be determined based on changes in the capacitance between the sensor body 252(1) and the lower piston cylinder 246 and the upper piston cylinder 256, between the sensor body 252(2) and the static target tube 262, or both.

In either case, a first distance between the sensor body 252(1) and the upper piston cylinder 256 or the lower piston cylinder 246 or a second distance between the sensor body 252(2) and the interior diameter of the static target tube 262 do not vary, so changes in the electrical signals produced by the sensor bodies 252(1) and 252(2) with respect to those areas may be indicative of a change in the dielectric of the fluid mixture. In an example, the sensor bodies 252 may be capacitively coupled to one or more of the upper piston cylinder 256, the lower piston cylinder 246, or the dynamic target tube 248, and a capacitive change along the length of the sensor body 252(1) may represent the position of the dynamic target tube 248. Moreover, temperature drift that may otherwise cause inaccurate position measurements may be calibrated relative to temperature-induced changes in the static measurements from the sensor 254(2) based on the sensor body 252(2) in the static target tube 262.

It should be appreciated that the movement of the check disk 230 and thus the dynamic target tube 248 may be caused by the fluid mixture flowing through the opening and pushing the check disk 230. However, it is important to understand some of the nuances of the fluid flow.

As the fluid mixture flows into the inlet 212 substantially horizontally, the inlet transition 214 may direct the fluid flow downward at an angle α. In one or more embodiments, the angle α may be between ninety degrees and one hundred thirty-five degrees (90°≤α≤135°) relative to an axis of the inlet 212. The change in direction of the fluid flow may cause a decrease in the momentum of the fluid mixture as the fluid mixture interacts with the downward-angled internal walls of the inlet transition 214. The change in direction may also increase turbulence in the fluid flow. Concurrently with the change in direction, the cross-sectional shape changes from a circular shape having a first cross-sectional area at a first end of the inlet transition 214 to a second shape having a second, larger cross-sectional area at a second end of the inlet transition 214. The change in shape and cross-sectional area may further contribute to the turbulence in the flow of the fluid mixture and may rapidly decrease the fluid pressure. In response to the pressure change, the shape change, and the directional change and aided by the increased turbulence, the entrained gas may separate from the fluid mixture and expand. Since the entrained gas travels at a greater velocity than the fluid mixture, the release of the gas may cause the released gas to build up rapidly at the opening 220 in the valve seat 218 and against the check disk 230. Since the released gas is more compressible than the fluid components of the fluid mixture, the released gas may need to accumulate to a volume that can apply sufficient pressure to move the check disk 230 to a greater extent than the fluid components of the fluid mixture have already moved the check disk 230. The faster movement of released gas may build up rapidly until a pressure is reached that is greater than the bias forces (a bias threshold) on the check disk 230. When the accumulation of the released gases reaches that threshold (which may vary based on the fluid components'current displacement of the check disk 230), the released gas may push the check disk 230 rapidly, releasing the gas pressure into the outlet chamber 222. Once the gas pressure is dissipated, the bias forces from gravity and the biasing spring 242 may push the check disk 230 toward the opening 220 until the position of the check disk 230 is stopped by the incompressible fluid components of the fluid mixture or by the valve seat 218. The released gas may build up again and the cycle may repeat. Since the released gases move faster than the fluid mixture, since the released gases expand rapidly upon release from entrainment, and since the inlet chamber 216 extends vertically and the gas is lighter than the fluid mixture and rises rapidly through the fluid mixture as it is released from entrainment, the released gases may cause the check disk 230 and the associated dynamic target tube 248 to oscillate rapidly between a first height h₁ associated with the level of the flow of the incompressible fluid components of the fluid mixture and one or more second heights h₂ᵢ that are greater than the first height h₁. The gas-related height may represent a difference in the height h₂ to which the gas pushes the check disk 230 relative to a height h₁ at which the incompressible fluid components push the check disk 230.

In one or more embodiments, a volume of the gas in the fluid mixture may be determined by the circuitry 201 or by the monitoring system 102 (in FIG. 1) based on one or more of the frequency of the gas-related movement of the check disk 230 or the extent of displacement of the check disk 230 due to the released gas (i.e., gas-related height h₂). It should be appreciated that the force supplied by the biasing spring 242 may vary depending on the extent it is already compressed when the force of the gas is applied, so the portion of the biasing force supplied by the biasing spring may also vary over time. This compression-related variation may be taken into account in determining the gas flow parameters.

Additionally, the cross-sectional area of the inlet transition 214 may increase from a first cross-sectional area at the inlet 212 to a second cross-sectional area at the inlet chamber 216, thereby decreasing the pressure and slowing the fluid flow. In effect, the valve 250 may be considered as a Venturi tube with a narrow inlet 212, a wider central portion (e.g., inlet chamber 216, opening 220, and outlet chamber 222), and a narrower outlet 226. Bernoulli's equations can be used to determine the continuity equation that relates the fluid velocity V to the cross-sectional area A of the conduit as follows:

A₁V=A₂V₂, (1)

where A₁ may represent a cross-sectional area at a first point (at a location corresponding to the inlet 212, V₁ may represent a velocity of the fluid mixture at the first point, A₂ may represent a cross-sectional area at a second point in the fluid flow path (at a location corresponding to an end of the inlet transition 214, the inlet chamber 216, the opening 220, the outlet chamber 222, or the outlet transition 224), and V₂ may represents a velocity of the fluid mixture at the second point. Based on Equation 1, as the cross-sectional area increases along a length of the inlet transition 214 from A₁ to A₂, the corresponding fluid velocity decreases such that the fluid mixture slows down as it flows through the inlet transition 214 and into the inlet chamber 216. The decreasing velocity of the flow of the fluid mixture may contribute to increasing turbulence, transitioning the fluid mixture from a laminar flow to a turbulent flow. While Equation 1 applies to incompressible fluids, such as water, oil, and other incompressible fluids, the fluid mixture may exhibit characteristics of both an incompressible fluid (for example, with respect to oil, water, debris, chemicals, or any combination thereof) and a compressible fluid (for example, with respect to entrained gas and separated gas within and around the fluid flow). The continuity equation for compressible fluids takes into account the density ρ of the fluid mixture and may be expressed as follows:

ρ₁A₁V₁ =ρ₂A₂V₂ (2)

where ρ₁ and ρ₂ represent the fluid densities at the first location and the second location, respectively. The fluid density ρ may be neglected when the fluid density remains unchanged, such as when the entrained gas remains entrained in the fluid mixture. The compressibility of the entrained gas may be neglected with respect to the fluid density of the fluid mixture and the fluid mixture may be treated as having a homogenous fluid mixture with respect to density, such that the densities are assumed to be equal (ρ₁=ρ₂).

The change in momentum, the increased turbulence, the change in the shape of the fluid path, and the change in cross-sectional area provided by the inlet transition 214 and the inlet chamber 216 may cause the entrained gas to separate from the fluid mixture. In particular, the inlet chamber 216 that couples the valve opening 220 and to the outlet chamber 222 through the multiphase flowmeter 200 may have a larger cross-sectional area (larger volume) than one or both of the inlet 212 and the inlet transition 214, providing an expansion chamber that may facilitate release of the entrained gas from the fluid mixture. The released gas may be more compressible than the fluid and may have a significantly higher velocity than the remaining fluid mixture. The combination of the higher velocity and the compressibility of the released gas may cause the check disk 230 to move back and forth rapidly, and the frequency of the oscillations or vibrations determined from the data determined by the sensors 254 may be used to determine one or more parameters of the released gas, such as the volume of the gas released from the fluid mixture. As used herein, the term “oscillation” may refer to a periodic or aperiodic back-and-forth movement of the check disk 230 at a regular speed. As used herein, the term “vibration” may refer to aperiodic or periodic back and forth movement of the check disk 230 at irregular speeds and at variable frequencies.

As the gas escapes entrainment, the fluid density of the fluid mixture changes since the released gas is compressible, and the fluid components and any remaining entrained gas is incompressible. Additionally, the velocity of the released gas may be significantly greater than the velocity of the incompressible fluid components of the remaining fluid mixture. Further, the released gas may take up a small portion of the cross-sectional area while the incompressible fluid may take up the remainder of the cross-sectional area. Accordingly, equation 2 may be rewritten as follows:

ρ₁A₁V₁=ρ₂A₂V₂+ρ₃A₃V₃ (3)

In Equation 3, the second density ρ₂ may represent the density of the released gas, the second cross-sectional area A₂ may represent the portion of the cross-sectional area that is occupied by the released gas, and V₂ may represent the velocity of the released gas. Additionally, in Equation 3, the third density ρ₃ may represent the density of the incompressible fluid components (in some cases the first and third densities may be assumed to be approximately equal, i.e., ρ₃≈ρ₁), the cross-sectional area A₃ may represent the remaining portion of the cross-sectional area that is occupied by the incompressible fluid components, and the velocity V₃ may represent the velocity of the incompressible fluid components.

In some embodiments, the released gas may move faster than the fluid mixture from which it was released, and the volume of released gas may vary over time. In some instances, the fluid mixture may occupy less than an entirety of the cross-sectional area and the fluid pressure may be further reduced. The density variations, volume variations, pressure variations, and velocity variations may render a conventional Venturi tube unable to reliably determine a differential pressure or to determine information from which fluid flow parameters may be determined. However, the flowmeter 200 may be configured to determine flow parameters associated with the fluid flow over the range of pressures, flow rates, flow volumes, densities, and so on.

In one or more embodiments, changes in the fluid composition may provide different dielectric characteristics. In one or more embodiments, one or more of the circuitry 201 or the monitoring system 102 may be configured to determine the composition or “cut” of the fluid mixture based on changes in the signal strength determined a capacitive coupling between the sensor bodies 252 and the upper piston cylinder 256, the lower piston cylinder 246, the dynamic target tube 248, the static target tube 262, or any combination thereof. In an embodiment, the position sensors 254 and the sensor bodies 252 are indicated to be capacitive, and may be sensitive to the fluid's composition in terms of its efficiencies in capacitance and insulation, which may be referred to as the fluid's dielectric constant value. A cut of the fluid mixture may be determined based on, at least in part, a change in the electrical signals produced by the position sensors 254 in response to the fluid mixture's efficiencies in capacitance and insulation. In an example, the changes in the electrical signals may be indicative of a change in the dielectric of the fluid mixture flowing through the piston housing 204 and the sensor chamber 258. In one or more embodiments, the composition or cut of the fluid mixture may be determined by the circuitry 201, the monitoring system 102, or any combination thereof based on the electrical signals. In one or more embodiments, the cut of the fluid mixture may be determined based on the electrical signals at least one of the position sensors 254 and based on a fluid density of the fluid mixture determined from pressure data from a pressure sensor within the sensor housing and temperature data of the fluid mixture from a temperature sensor within sensor housing.

During operation, the fluid mixture may flow through the inlet 212, and the inlet transition 214 may direct the fluid mixture downward to the inlet chamber 216, which may redirect the fluid mixture upward toward the valve seat 218 and the associated opening 220. The fluid mixture may push the check disk 230, which may move within the outlet chamber 222, expanding the constriction for the fluid path through the opening 220 and into the outlet chamber 222. As the check disk 230 moves away from the valve seat 218, the check disk 230 and the valve seat 218 may provide a varying constriction having a time-varying cross-sectional area of the fluid flow path through the opening 220 and between a top surface of the valve seat 218 and a bottom surface of the check disk 230 and into the outlet chamber 222. In one or more embodiments, a maximum size of the construction may be defined by the cross-sectional area of the opening 220, but the size of the constriction of the flow path may vary from approximately zero when the check disk 230 is biased against the valve seat 218 to the maximum size, enabling a variable constriction, which may as a function of the movement of the check disk 230 responsive to the fluid flow through the valve 150. This variable cross-sectional area provides a variable Venturi effect, which can be used to determine the flow rate of the fluid mixture at a wide range of flow rates and pressures.

In an example, a pump jack may have a pump cycle or period of six seconds in which each stroke includes a three second portion in which the fluid mixture is actively pumped through the flowmeter 200 and a three second portion as the pump jack resets. The multiphase flowmeter 200 may determine flow rates for a fluid mixture in which the flow volume and pressures vary with the operation of the pump jack cycle. In this example, the flowmeter 200 may experience a fluid pressure swing between less than 10 pounds per square inch (PSI) and to more than 850 PSI over a period of less than three seconds and then may experience a decrease in the fluid pressure from over 850 PSI to 10 PSI over a similar period. This change in pressure may be repeated with each cycle of the pump jack, e.g., every six seconds. The flow rate of the fluid mixture through the multiphase flowmeter 200 also varies from a very high flow volume to a very low flow volume as the fluid pressure varies. The variable Venturi effect provided by the check disk 230 relative to the valve seat 218 may allow the flowmeter 200 to measure the fluid flow rate across the entire spectrum of the pump jack cycle.

Conventional Venturi sensors may struggle to measure the flow rate of the fluid mixture with such wide variations because such sensors are typically tuned for accurate measurement within a narrow range (such as a range of flow rates that vary within a ratio of 2 to 1 (e.g., 400 Gallons per Minute (GPM) to 200 GPM). In contrast, the variable Venturi functionality provided by the check disk 230 may enable flow rate measurements for fluid flows ranging from a low flow rate of a trickle to a high flow rate. In one non-limiting example, the flowmeter 200 may measure fluid flow rates for a fluid mixture that has a variable flow that ranges from tens of barrels per day to tens of thousands of barrels per day (1:10,000 ratio). The range of variability may depend, in part, on the implementation including the diameter of the conduits. The range of the Venturi functionality provided by variable constriction (i.e., the valve seat 218 and the check disk 230) of the flowmeter 200 may be configured to measure variable fluid flows, such as those produced by a pump jack in the crude oil production industry, across any selected range of fluid flows, bounded only by the limits of the production environment. For example, the flowmeter 200 may be configured to measure fluid flow rates across a range of fluid flows that may vary from low to high by a factor of 1000s, 10,000s, or more, which ranges are not supported by conventional Venturi devices.

In one or more embodiments, the cross-sectional area of the opening of the valve seat 218 may define a maximum cross-sectional area of the narrowing constriction (i.e., A₂₂₀=πR², R represents the radius of the opening 220, and A₂₂₀ represents the maximum cross-sectional area of the opening 220 of the valve seat 218). When the check disk 230 is biased against the valve seat 218, the cross-sectional area of the opening is at a minimum (i.e., approximately zero within limits of the valve seal). As the check disk 230 moves, the size of the opening varies within a range of zero to the maximum cross-sectional area of the opening according to the following equation:

πR²≥2πRH (4)

where the variable h represents a displacement between the bottom surface of the check disk 230 and the top surface of the valve seat 218. In equation 4 above, movement of the check disk 230 relative to the valve seat changes the size of the narrowing constriction from zero (valve closed) to open (maximum cross-sectional area (πR²)). Between the valve closed position and the valve “fully open” position, the cross-sectional area varies as a function of a surface area of a cylinder. Since the radius R on both sides of the equation is the same, equation 4 may be simplified as shown in Equation 5 below:

R≥2h (5)

In one or more embodiments, this equation represents the variable constriction across a wide range of flow volumes and pressures of the fluid mixture. At low volumes where the narrowing constriction provided by the valve seat 218 is too large to restrict the flow of the fluid mixture, the check disk 230 narrows the constriction, creating a pressure differential that enables accurate measurement of fluid flow across the range of flow volumes. In one or more embodiments, when the fluid mixture pushes the check disk 230, the size of the constriction increases from zero to a fully open position in which the height (displacement) h is greater than or equal to half of the radius R of the opening 220 of the valve seat 218 (i.e., h≥R/2), the position data corresponding to displacement of the check disk 230 relative to the surface of the valve seat 218 may be used to determine the flow rate. In the range where the fluid mixture pushes the check disk 230 to an open position that is less than half of the radius R of the opening 220 of the valve seat 218 (i.e., h<R/2), the check disk 230 provides a variable Venturi that restricts the fluid flow.

In one implementation, one or more sensors 152 may include a pressure sensor within the sensor housing 206, which pressure sensor may produce pressure data. The one or more sensors 152 may include a temperature sensor within the sensor housing 206, which temperature sensor may produce temperature data. In one or more embodiments, the processor circuitry 201 may receive a signal indicative of a pressure of the fluid mixture from the pressure sensor, temperature data from the temperature sensor, and position data corresponding to displacements of the check disk 230 from one or more position sensors (such as the sensors 254) of the one or more sensors 152. Circuitry 201 within the circuit housing 208 may use the temperature data and the pressure data to determine a fluid density, which may improve the accuracy of the flow data and the cut data The circuitry 201 may be configured to determine multi-phase flow data of the fluid mixture based on the fluid density and the position data and based signal variations indicative of the composition of the fluid mixture (such as changes in the dielectric of the fluid mixture). In some implementations, the multi-phase flow data may be inferred or determined based on changes in the position data.

In addition to determining the flow rate, the circuitry 201 may be configured to determine other parameters of the fluid mixture, such as a volume of gas within the fluid mixture, based on the change in position of the check disk 230 over time. In some implementations, the circuitry 201 may determine the volume of gas within the fluid mixture based on vibrations (or oscillations) of the check disk 230, which may be determined based on signals from the one or more position sensors 254. The frequency of the vibrations may be derived from changes in the position data, and the frequency may be indicative of the volume of gas flow.

In some implementations, the vertical flow of the fluid mixture through the opening 220 of the valve seat 218, the change in pressure due to expansion of the fluid mixture as it moves from the inlet 212, through the inlet transition 214, and into the inlet chamber 216, the turbulence due to the change in direction (horizontal to vertical and back to horizontal) of the fluid path, or any combination thereof may cause or facilitate separation of the entrained gas from the fluid mixture and expansion within the inlet chamber 216 with gas rapidly flowing through the opening 220 into the outlet chamber 222. The release of the entrained gas may introduce vibrations (or oscillations) in the position of the check disk 230.

In one or more embodiments, the fluid mixture may push the check disk 230 open sufficiently to allow the entrained volume of the fluid mixture (oil, water, chemicals (or other entrained liquid), and any remaining entrained gas) to pass through the opening 220 of the valve seat 222 and into the outlet chamber 222. The released, expanded gas may build up in the inlet chamber 216 until it reaches a pressure that is greater than a threshold pressure that exceeds the forces applied to the check disk 230 by gravity and by the biasing spring 242. Since gas moves faster than the remaining fluid mixture, once the gas pressure is sufficient to move the check disk 230 beyond the position to which it was moved by the fluid mixture, the released (separated) gas may force its way through the opening 220 of the valve seat 222 in a “packet” or “accumulated mass,” pushing the check disk 230 very rapidly, dissipating the accumulated pressure, and the biasing spring 242 may restore the check disk 230 to equilibrium, which may be at a displacement corresponding to the fluid mixture flowing through the valve seat. The cycling of packets or accumulated masses of gas pushing the check disk 230 to escape and the biasing spring 242 restoring the check disk 230 to equilibrium may cause the check disk 230 and the piston 236 to vibrate (vibrate rapidly back and forth as indicated by the piston movement arrow 270 and the check disk movement arrow 370 (in FIG. 3)). The released gas moves quickly through the opening 220, dissipating the pressure, and allowing the restoring forces of gravity and the biasing spring 242 to move the check disk 230 back to the surface of the remaining fluid mixture. The released gas may then continue to build up within the inlet chamber 216 before repeating the process.

The vibrational frequency (or oscillating frequency) of the check disk 230 and the associated piston 236 may be significantly different when the movement is caused by the gas packets as compared to the incompressible fluid components of the fluid mixture. The circuitry 201 or the monitoring system 102 may determine the volume of gas within the fluid mixture based on data indicative of the frequency of the vibrations (or oscillations) determined from position data, based on the relative height of the rapid displacement, based on the rate of change of the position, other data, or any combination thereof. The position data may be determined based on a position of the dynamic target tube 248 relative to the sensor body 252(1).

In some implementations, the circuitry 201 or the monitoring system 102 may be configured to determine one or more other parameters of the fluid mixture, such as a volume of oil, or a volume of liquid within the fluid mixture based on one or more of the position measurement data, the fluid density, an electrical parameter associated with one or more of the sensors, other sensor data, or any combination thereof. In an embodiment where the liquid portion of the fluid mixture has a substantially constant chemical composition, the cut of oil versus liquid may be determined based on electrical signals from the one or more sensors 154. The fluid mixture may flow around the sensor bodies 152, which may be sensitive to the fluid's composition in terms of its efficiencies in capacitance and insulation, which may be referred to as the fluid's dielectric constant value. Electrical signals produced by the sensors 252 may change with changes in the composition of the fluid mixture, enabling determination of composition of the fluid mixture based on changes in the electrical signals produced by the sensors 154. For example, water may have a dielectric constant of approximately 80.4 at a temperature of 20 degrees Celsius, while oil may have a dielectric constant of approximately 2.1 to 2.4, depending on various aspects of the makeup of the oil mixture. A fluid mixture comprised of oil and water would have a dielectric constant that would fall somewhere between 80.4 and 2.1, and the effective dielectric constant may be determined from changes in the electrical signals providing a reliable measurement of the cut of oil in the fluid mixture. Since the distance and the surface area do not change, changes in the composition of the fluid mixture flowing between the sensor bodies 252 and the dynamic target tube 248 or within the static target tube 262 may cause the electrical signals to change (e.g., current amplitude or another electrical parameter), which can be readily determined and used to infer the fluid composition (for example, the cut of oil versus water). The circuitry 201 may be configured to determine one or more cuts (components) of the incompressible portion of the fluid mixture based on the electrical signals from the position sensors 254.

In some implementations, the salinity of the water may alter the dielectric constant. Some studies have shown that, at 20 degrees Celsius, the dielectric of a saltwater solution may vary between approximately 80 and 45 depending on the salt concentration. As the salt concentration increases, the electrical permittivity of the solution decreases. In some implementations, the one or more sensors 152 of the flowmeter 200 may include one or more salinity sensors to determine the salt content of the fluid mixture so that the saltwater component of the dielectric of the liquid component may be determined. Based on this information, the change in the dielectric constant of the fluid mixture may provide a reliable measurement of the cut of water and oil in the fluid mixture.

In some implementations, the one or more sensors 152 may include a capacitive sensor, which may be used to determine the dielectric constant of the fluid mixture. Alternatively, the sensor bodies 252(1) and 252(2) may be capacitive such that changes in the composition of the fluid mixture may alter the signal strength between the sensor bodies 252 and the target tube 248, the upper piston cylinder 256, the lower piston cylinder 246, or any combination thereof. In some implementations, the sensor bodies 252(1) and 252(2) may experience the dielectric changes and the dielectric may be determined from the changes in the electrical signals. Other implementations are also possible.

In one or more embodiments, the one or more sensors 152 may include a spectrometer that may be configured to irradiate the fluid mixture with one or more optical frequencies and to determine data indicative of the chemical content of the fluid mixture based on reflection or absorption data. In one or more embodiments, the one or more sensors 152 may include chemical sensors, each of which may be configured to measure for the presence of a specific chemical within the fluid mixture. In one or more embodiments, the one or more sensors 152 may include Hall-effect sensors configured to determine position based on a magnetic field, ultra-wideband radar signals to determine position data based on radar reflections, other sensors, or any combination thereof. Other implementations are also possible.

Conventionally, the cut of oil and water of a selected well is measured using a device that is coupled to the output of the well for a period of time to sample the well's production. Once the measurement is taken, the device is typically decoupled from the well to be used to test other wells. Conventionally, it is assumed that the cut of oil and water remains substantially constant for a selected well over a period of time, so the cut of the selected well's production is estimated for the period of time until the cut is measured again. Unlike conventional systems, the flowmeter 200 may be configured to determine the various components of the fluid composition in real time, while also preventing back flow of the fluid mixture into a well, making it possible to accurately determine the production of crude oil and natural gas from the well. Moreover, unlike conventional Venturi tubes (Venture meters) that utilize two pressure sensors to measure a differential pressure, the flowmeter 200 described herein may be configured to determine flow data based on position data associated with a check disk 230, electrical signals produced by the position sensors 254, and a fluid density.

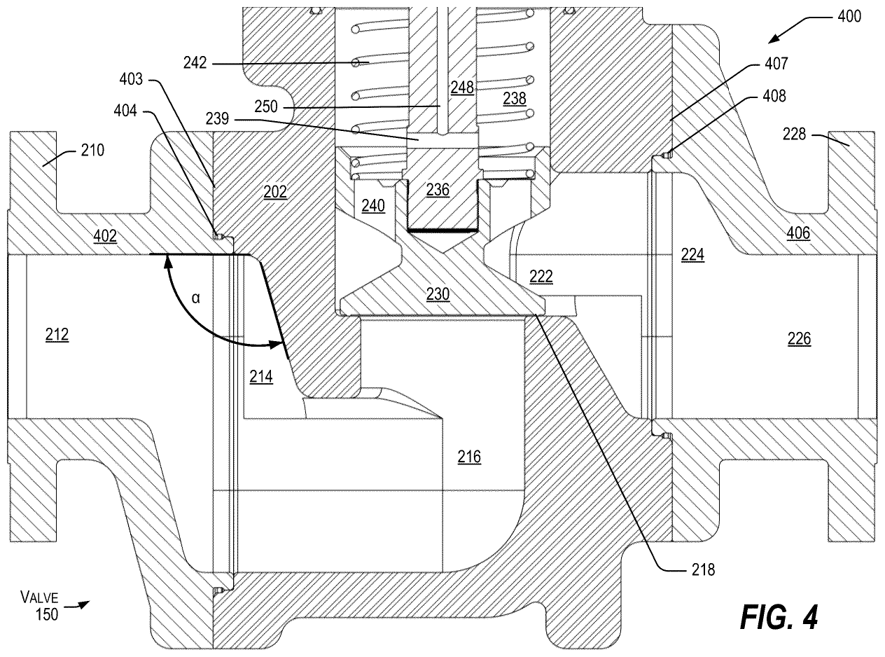

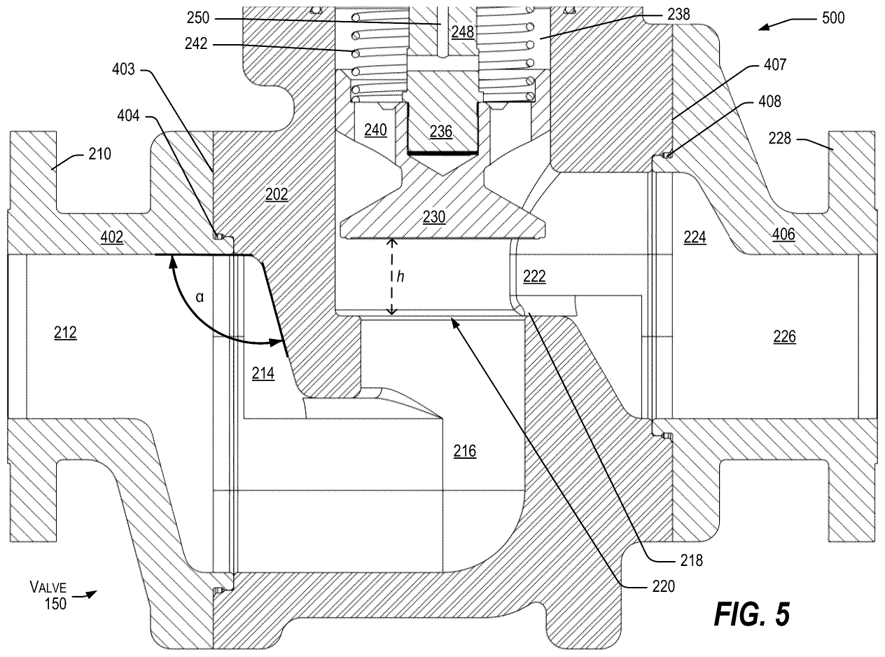

FIG. 4 depicts a cross-sectional diagram 400 of a portion of the valve 150 of the multi-phase flowmeter 200 with the check disk 230 in a closed position, in accordance with certain embodiments. FIG. 5 depicts a cross-sectional diagram 500 of the portion of the valve 150 of the multi-phase flowmeter 200 with the check disk 230 in an open position, in accordance with certain embodiments. The portion of the valve 150 depicted in FIGS. 4 and 5 may include all the elements of FIGS. 2 and 3, with some additional features called out.

The valve housing 202 may include an inlet housing 402, which may include the inlet flange 210. The inlet housing 402 may define the cross-sectional dimension of the inlet 212, which may extend substantially horizontally through the inlet housing 402. The inlet housing 402 may be coupled to the valve housing 202 at a joint 403, which may be sealed by an O-ring 404 to prevent fluid flow between the inlet housing 402 and the valve housing 202.

The valve housing 202 may include an outlet housing 406, which may include the outlet flange 228. The outlet housing 406 may define the cross-sectional dimension of the outlet 226, which may extend substantially horizontally through the outlet housing 406. The outlet housing 406 may be coupled to the valve housing 202 at a joint 407, which may be sealed by an O-ring 408 to prevent fluid flow between the outlet housing 406 and the valve housing 202.

In FIG. 4, the check disk 230 is in a closed state, such that the distance or height h between the valve seat 218 and a bottom of the check disk 230 is zero (i.e., h₀ meaning that the check disk 230 is in contact with the valve seat 218). In this state, the valve 150 is configured to prevent fluid flow from the outlet chamber 222 to the inlet chamber 216 through the opening 220. In the context of a pump jack, during a reset portion of the pump jack cycle, the pressure in the conduit may decay to approximately zero or even a negative pressure or to a pressure that is less than the bias force applied by the spring 242 and the weight of the check disk 230, and the check disk 230 is biased closed by the spring 242 to prevent the fluid mixture from passing through the valve 150 from the outlet 226 to the inlet 212.

In FIG. 5, the check disk 230 is in an open state and the fluid mixture has pushed the check disk 230 away from the valve seat 218 by a displacement (height) h. The check disk 230 may open in response to the fluid mixture during a pump portion of the cycle of the pump jack. The displacement h may include a further displacement (e.g., h₁, h₂, h₃, etc.) caused by the released gas pushing through the opening 220 and escaping to the outlet chamber 222 and to the outlet conduit (not shown).

In one or more embodiments, the displacement h of the check disk 230 may vary based on the pressure of the fluid mixture. Over the course of a pump jack cycle, the displacement h of the check disk 230 may increase during the pumping portion of the cycle and then decay with the decreasing flow of the fluid mixture until the check disk 230 contacts the valve seat 218.

The fluid flow path through the valve 150 also incorporates a fluid path into the piston housing 204 through the fluid openings 240 in the check disk body 235, through fluid openings in the separator 247, and through openings into the lower cylinder 246. To prevent the piston 236 and dynamic target tube 248 from getting stuck, the upper cylinder 256 may include fluid windows 260, which may allow for the fluid mixture to exit from the lower cylinder 246 and the upper cylinder 256 and from the target tube 248 through the fluid windows 260. The fluid mixture may then travel around the outside of the upper cylinder 256 and the lower cylinder 246 and through openings in the piston housing flange 244 and openings through the separator 247. The fluid mixture may return to the outlet chamber 222 through the openings 240 in the check disk body 235.

The fluid flow path into and out from the piston housing 206 may have the added benefit of exposing both sensor bodies 252 to the fluid mixture. Thus, the sensor bodies 252 may each be exposed to the temperature of the fluid mixture such that both sensor bodies 252(1) and 252(2) are exposed to the fluid temperature, allowing for calibration of temperature-related drift. Additionally, each sensor body 252 may be exposed to the fluid composition for determining the cut, for example, based on changes in the dielectric of the fluid mixture.

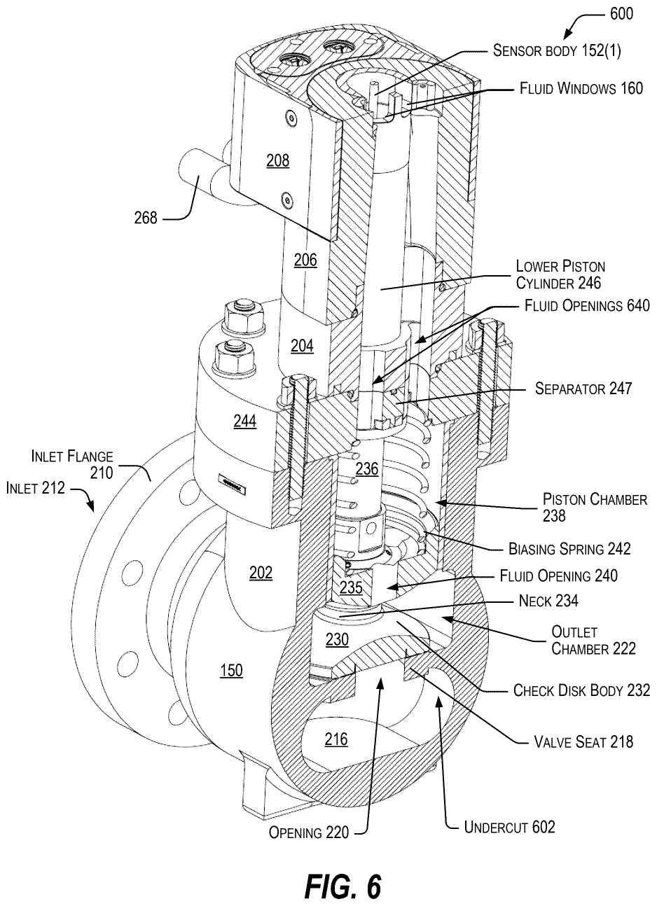

An example of an embodiment of the flowmeter 200 is described below with respect to FIG. 6, which shows at least some of the openings between the outlet chamber 222 within the valve housing 202 and the sensor housing 206. It should be appreciated that the embodiment depicted in FIG. 6 includes an inlet chamber 216 that is oriented horizontally instead of vertically as described with respect to FIGS. 2-5.

FIG. 6 depicts a cross-sectional isometric view 600 of an embodiment of the multi-phase flowmeter 200 of FIG. 2, including a fluid windows to enable fluid flow through the sensor housing 206, in accordance with certain embodiments. In this embodiment, the flowmeter may include all the elements of the flowmeters described above with respect to FIGS. 1-5, except that the shape of the inlet chamber 216 is oriented differently.

The flowmeter 200 may include an inlet chamber 216 that has a substantially elliptical shape, which has a major axis that extends horizontally and a minor axis that extends vertically toward the opening 220 through the valve seat 218. In the illustrated example, the inlet chamber 216 extends horizontally past the edges of the opening 220 and forming an undercut 602 the extends past the valve seat 218. In one or more embodiments, the undercut 602 may contribute to turbulence in the flow of the fluid mixture, encouraging release of the entrained gas.

While in this example, the inlet chamber 216 is depicted as having a horizontal orientation, in some embodiments, the undercut 602 could be included with the inlet chamber 216 having the vertical orientation as depicted in FIGS. 2-5. In such an implementation, the undercut 602 may also contribute to turbulence in the fluid mixture that may facilitate release of the entrained gas.

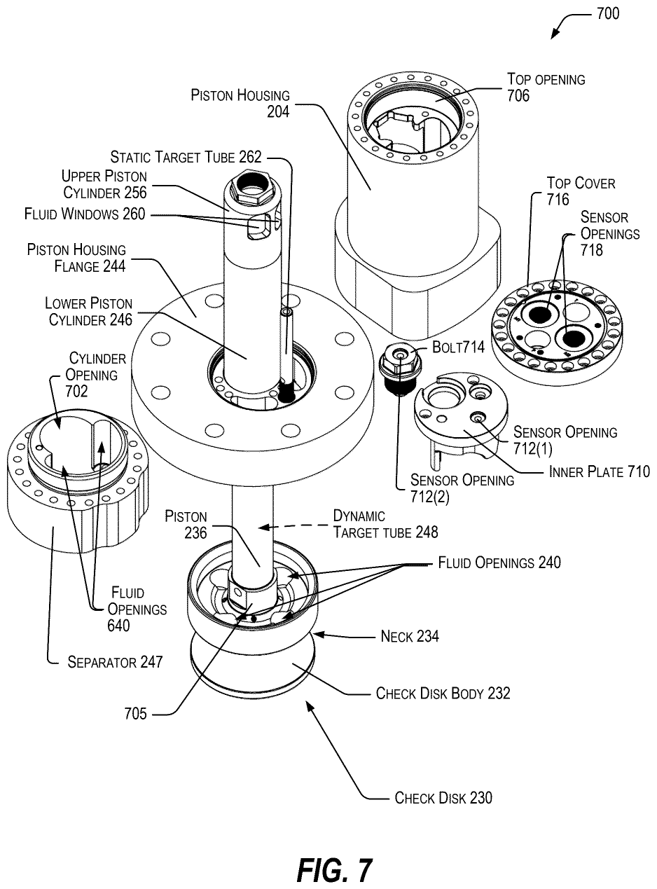

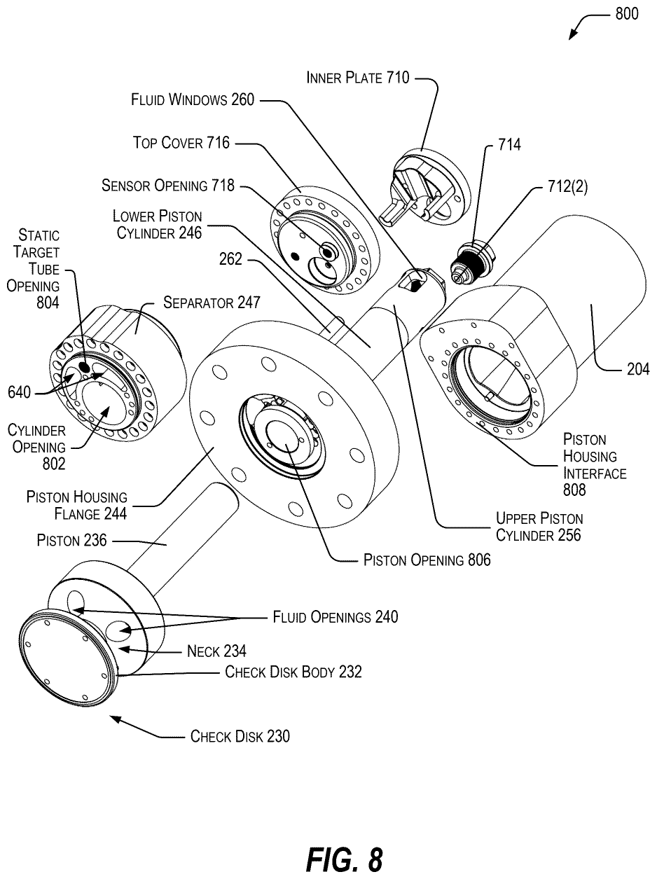

The check disk 230 may include one or more openings 240 that extend through the check disk body 235. The separator 247 may include openings, such as fluid openings 640, which may extend from the piston chamber 238 to an area surrounding the lower piston cylinder 246 and the upper piston cylinder 256. The separator 247 may also include other openings (such as shown in FIGS. 7 and 8) that may enable the fluid mixture to flow into the lower piston cylinder 246 and the upper piston cylinder 256. The flow path provided by the openings 240, the fluid opening 640, and other openings may enable a portion of the fluid mixture to flow around the sensor bodies 252, exposing each sensor body 252(1) and 252(2) to the temperature and composition of the fluid mixture.

As shown, the upper piston cylinder 256 may include fluid windows 260. The fluid windows 260 may have curved shape along at least one side. The fluid windows 260 may enable the fluid mixture to escape from the lower piston cylinder 246 and the upper piston cylinder 256 so that the pressure does not equalize on both sides of the dynamic target tube 248, locking the piston 236 and preventing movement of the piston 236. In other words, the fluid windows 260 may be configured to prevent “hydrostatic lock.”

In the illustrated example, the check disk 230 has a shape that includes a base portion 232, a neck 234, and a body portion 235 including fluid openings 240. The neck 234 serves to lighten the check disk 230 and to allow for fluid openings 240 through the body portion 235 to allow fluid flow into the piston housing 204.

FIG. 7 depicts an exploded, top perspective view of components 700 of the multi-phase flowmeter of FIGS. 1-6, in accordance with certain embodiments. The separator 247 includes a cylinder opening 702 and fluid openings 640. The cylinder opening 702 may be sized to receive an end of the lower piston cylinder 246. Each of the fluid openings 640 may have an elongate shape that extends at least partially around the lower piston cylinder 246 when the separator 247 is inserted into the opening of the piston housing flange 244.

The check disk 230 may include a check disk body 232, a neck 234, and a body portion 235. Fluid openings 240 extend through the body portion 235 around a periphery of an attachment ring 705 sized to receive and couple to the piston 236 to secure the piston 236 to the check disk 230.

The piston housing flange 244 is shown that includes an opening that is configured to fit over and around the piston 236. The separator 247 may be arranged in the opening of the piston housing flange 244 such that the separator 247 secures the piston 236. The openings 260 in the body portion of the check disk 230 may be in fluid communication with the openings 640 in the separator 247. The lower piston cylinder 246 may be coupled to the separator 247 over the piston opening 702 to receive the dynamic target tube 248. The static target tube 262 may be coupled to the separator 247 between the fluid openings 640. The upper piston cylinder 256 may be coupled to the lower piston cylinder 246 and may include the fluid windows 260. As shown, the fluid windows 260 may have an arch shape or may be rounded. In one or more embodiments, the fluid windows 260 may be spaced apart and positioned such that the fluid mixture flows out of the fluid windows 206 and down and around the static target tube 262. A bolt 714 may include a sensor opening 712(1) sized to receive the sensor body 252(1) and to couple an inner plate 710 to the upper piston cylinder 256.

The piston housing 204 is shown including a top opening 706, which depicts openings for access to the upper piston cylinder 256. In an example, the sensor body 252(1) may be slotted into the sensor opening 712(1) after the inner plate 710 is coupled to the upper piston cylinder 256. The piston housing 204 may include multiple openings configured to receive fasteners to couple a top cover 716 over the top opening 706.

The inner plate 710 may be configured to engage the upper piston cylinder 256 and structure within the piston housing 204. The inner plate 710 may include a second sensor opening 712(2) configured to receive a second sensor body 252(2) and to secure the sensor body 252(2) and align it to the static target tube 262.

The top cover 716 may include sensor openings 718 through which the sensor bodies 252 may extend. The top cover 716 may also include fastener openings to receive fasteners configured to couple the top cover 716 to the top opening 706 of the piston cover 204. The components 700 are also shown in FIG. 8 below from a bottom perspective view, which makes some of the openings more visible.

FIG. 8 depicts an exploded, bottom perspective view 800 of the components 700 of FIG. 7 of the multi-phase flowmeter 200 of FIGS. 1-6, in accordance with certain embodiments. As shown, the check disk 230 includes a check disk body 232, a narrowing feature or neck 234, and a body portion 235. The body portion 235 may include fluid openings 240, which may enable a portion of the fluid mixture to pass through the body portion 235 into the piston chamber 238. The piston 236 is connected to the body portion 235 of the check disk 230 and is configured to move with the check disk 230. The upper portion of the piston 236 may include the lumen 250 and side openings that enable fluid flow into the lumen 250.

The separator 247 includes the fluid openings 648 and the cylinder opening 702. In this view, a sensor opening 712 is shown that is configured to receive the sensor body 252(2) and to secure the static target tube 262. Additionally, the separator 247 may include a plurality of openings to receive fasteners configured to secure the separator 247 to the piston housing flange 244.

The piston housing flange 244 may include a piston opening 806 that is sized to receive the piston 236. As previously mentioned, the piston 236 may include a lumen 250 and openings to the sides to receive a portion of the fluid mixture. The lumen 250 and the piston 236 may form the dynamic target tube 248 to receive a portion of the sensor body 252(1), which may determine data indicative of the position of the check disk 230 based on the position of the piston 236 relative to the sensor body 252(1).

The static target tube 262 and the lower piston cylinder 246 may be coupled to the piston housing flange 244. Additionally, the upper piston cylinder 256 may be coupled to the lower piston cylinder 246.

The top cover 716 is shown, and the sensor opening 718 is visible. The inner plate 716 is shown. The bolt 714 with the sensor opening 712(1) is depicted. The bolt 714 may couple to the upper cylinder housing 256 through the opening in the inner plate 716 (shown in FIG. 7). The piston housing 204 may fit over the assembly, and the top cover 716 may be bolted to its top (as seen in FIG. 7). The piston housing 204 may include a piston housing interface 808 that may be configured to couple the piston housing 204 to the piston housing flange 244 through the openings on the periphery of the separator 247.

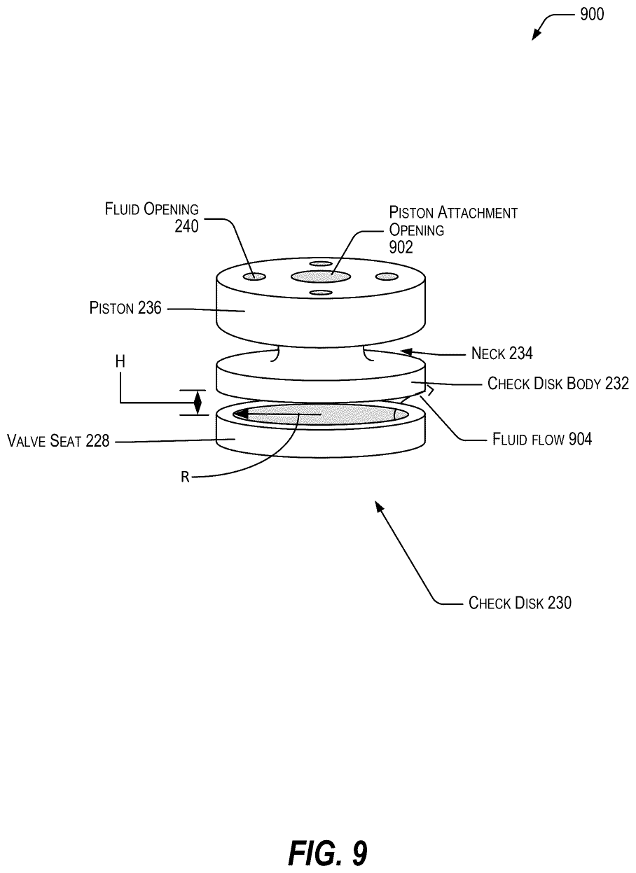

FIG. 9 depicts an expanded view of an embodiment 900 of the check disk 230 of the valve 150 of any of FIGS. 1-8 relative to the valve seat 218, in accordance with certain embodiments. In this example, the valve seat 218 is depicted as a stand-alone ring, but it should be appreciated that the valve seat 218 may be integrated into the valve housing 202.

The embodiment 900 is provided to enable a brief explanation of the escape path of the fluid mixture through the opening 220 in the valve seat 218 and between the valve seat 218 and the check disk 230. In general, the fluid mixture may flow through the opening 220 under pressure and may maintain a columnar shape until striking the check disk 230. In an illustrative example, when water is under pressure and flows through a nozzle of a hose, the water maintains its shape as a column until gravity overcomes the force of the water flow and the stream of water bends or otherwise dissembles. Similarly, the fluid mixture may maintain or form a columnar shape as it pushes through the opening 220 and strikes the check disk 230, moving the check disk 230 away from the valve seat 218.

For the purpose of understanding the variable narrowing feature provided by the check disk 230, the check disk 230 provides an opening that is proportional to one or more parameters of the flow characteristics of the fluid mixture. So, the size of inlet to the outlet chamber 222 may vary with the flow characteristics.

The valve seat 218 may provide an opening having a cross-sectional area that is defined as follows (as previously indicated with respect to FIG. 4 above):

Aₛₑₐₜ=πR² (5)

where R represents the radius of the opening 220. Equation 4 assumes that the opening 220 is circular. If the opening 220 has an elliptical shape or another shape, the equation for the cross-sectional area should be adjusted accordingly.

In the illustrated example, the check disk 230 is biased toward the valve seat 218 and may be pushed by the fluid mixture to a height h that defines a distance between the valve seat and a bottom surface of the check disk 230. This height h may be used to determine the cross-sectional area of the narrowing feature that provides a variable Venturi. When the fluid pressure pushes the check disk 230 to an open position where a height h of the check disk 230 relative to a top surface of the valve seat 218 is approximately equal to or greater than a half of the radius R (i.e., R/2), the cross-sectional area of the seat (Aₛₑₐₜ) defines the narrowing constriction of the Venturi of the valve 150. When the fluid pressure is low or insufficient to push the check disk to a height that is equal to half of the radius (i.e., h<R/2), the cross-sectional area of the narrowing constriction of the Venturi provided by the valve is a function of the displacement (h) of the check disk 230.

As discussed above with respect to FIG. 4, the cross-sectional area of the narrowing feature or constriction may be calculated using a simple cylindrical surface area function as follows:

A_{Constriction}=2πRH (6)

where h represents the displacement of the check disk 230 relative to the valve seat. Equation 6 holds because the fluid mixture escapes through the gap between the bottom surface of the check disk 230 and the top surface of the valve seat 218, which may be characterized mathematically as a surface area of a cylinder. Since the spring constant of the biasing spring 242 is known, the weight of the check disk 230, piston 236, and attachment components are known, and the gravitational forces are known, the pressure of the fluid mixture may be determined as a function of the displacement h of the check disk 230 across the entire range of fluid flows, from zero to a maximum defined by the cross-sectional area of the valve seat 230 (i.e., Aₛₑₐₜ).

If the check disk 230 were arranged in a direct path of the fluid flow, the momentum of the flow of the fluid mixture might influence the displacement directly. The shape of the flow path through the valve 150 redirects the fluid as the pressure is reduced, slowing the momentum such that the fluid pressure becomes the primary mover of the check disk 230 for determining the pressure causing the displacement.

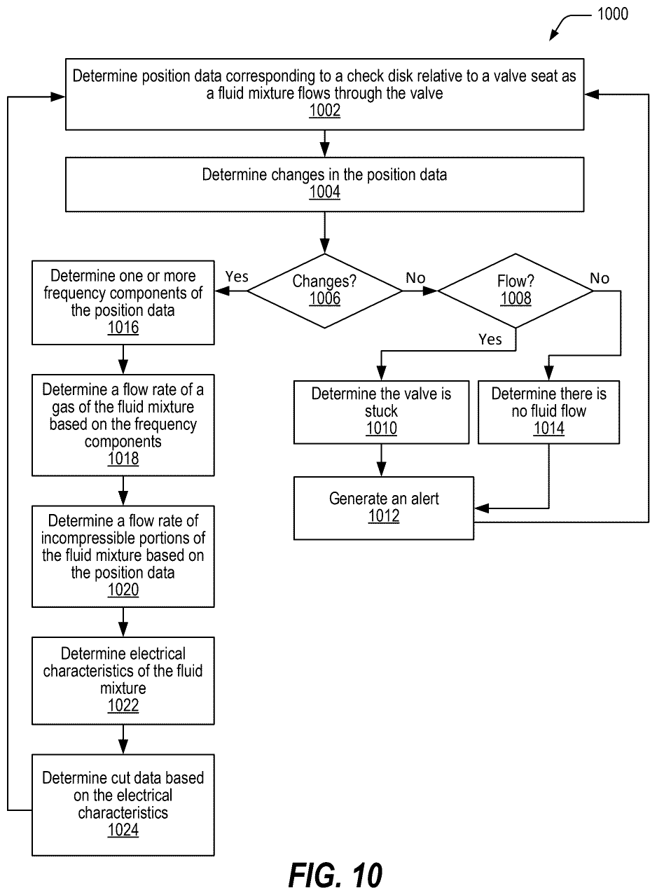

FIG. 10 depicts a flow diagram of a method 1000 of determining multiple phases of a fluid mixture flowing through a valve, in accordance with certain embodiments. At 1002, the method 1000 may include determining position data corresponding to a check disk 230 relative to a valve seat 218 as a fluid mixture flows through the valve 150. The position data may be determined by the one or more sensors 152, such as the sensor 254(1), as the target tube 248 provided by the piston 236 moves relative to the sensor body 252(1).

At 1004, the method 1000 may include determining changes in the position data. The rates of change may define slopes or frequencies that may be used to determine flow information. In some instances, the position data doesn't change. The determination may be made by the circuitry 201 or by the monitoring system 102. In an example, the flowmeter 200 may communicate data from the sensors 152 to the monitoring system 102 in real time.

At 1006, if the position data is not changing, the method 1000 may determine if the fluid mixture is flowing. At 1008, if the fluid mixture is flowing, the method 1000 may include determining the valve 150 is stuck, at 1010. At 1012, the method 1000 may include generating an alert. The alert may include a text message, a phone call, an email, or another electronic alert. In one or more embodiments, the alert may be sent to the monitoring system 102, one or more computing devices 126, or any combination thereof.

Returning to 1008, if the fluid mixture is not flowing, the method 1000 may determine that the fluid mixture is not flowing, at 1014. In this case, the method 1000 may return to 1002 to continue determining the position data.

Returning to 1006, if there are changes in the position data, the method 1000 may include determining one or more frequency components of the position data, at 1016. In an embodiment, the sensors 152 may be configured to capture data at a resolution of forty times per second or at another sample rate. In one or more embodiments, the sensors 152 may be configured to capture data at a selected frequency to provide a selected resolution.

At 1016, the method 1000 may include determining one or more frequency components of the position data. The frequency data may be determined from the rate of changes between position data measurements. The position data related to the incompressible fluids of the fluid mixture may change at a relatively low frequency, while position data related to released gases may change very rapidly and sometimes in short bursts of data.

At 1018, the method 1000 may include determining a flow rate of a gas of the fluid mixture based on the frequency components. In one or more embodiments, the flow rate of a gas may be determined based on at least one of the frequency of position changes over a period of time, changes in a displacement h of the check disk 230 over a period of time, a rate of change of the position over time, other data, or any combination thereof. In one or more embodiments, at least a portion of the displacement of the check disk 230 may occur rapidly in small bursts as the released gas builds up and races through the opening 222 while another portion of the displacement may occur more slowly in conjunction with flow of incompressible components of the fluid mixture.

At 1020, the method 1000 may include determining a flow rate of incompressible portions of the fluid mixture based on the position data. The incompressible components of the fluid mixture may include water, oil, chemicals, debris, or any combination thereof. As the fluid mixture flows through the valve 150, the check disk 230 may move at a much lower frequency with the flow of the fluid mixture, in part, because the change in volume of the fluid mixture does not change as rapidly as the motion associated with the released gas.

At 1022, the method 1000 may include determining one or more electrical characteristics of the fluid mixture. In one or more embodiments, one or more capacitive sensors may determine a change in the dielectric of the fluid mixture. In other embodiments, various sensors may be used to determine the components of the fluid mixture.

At 1024, the method 1000 may include determining cut data based on the one or more electrical characteristics. In an example, the dielectric provided by oil may be less than that of water, chemicals, and so on. Based on changes in the capacitance, the determined dielectric may be indicative of the cut of oil in the fluid mixture.

In the above discussion, the position sensors 254 and the sensor bodies 252 are indicated to be capacitive, and the position of the dynamic target tube 248 may be determined based on a change in the capacitance along a length of the sensor body 252(1) as the dynamic target tube 248 moves relative to the sensor body 252(1) and the extent of the sensor body 252(1) that is within the lumen 250 of the dynamic target tube 248 changes. In other embodiments, the sensors 152 configured to determine position data may include radar, magnetic sensors, resistive sensors, other sensors, or any combination thereof.

Additionally, in the above discussion, the position sensors 254 and the sensor bodies 252 are indicated to be capacitive, and may be sensitive to the fluid's composition in terms of its efficiencies in capacitance and insulation, which may be referred to as the fluid's dielectric constant value. A cut of the fluid mixture may be determined based on, at least in part, a change the electrical signals produced by the position sensors 254 in response to the fluid mixture's efficiencies in capacitance and insulation. In one or more embodiments, the position sensors 254 and sensor bodies 252 may be replaced with other types of sensors, such as Hall-effect sensors, ultra-wideband radar sensors, optical sensors, other sensors, or any combination thereof. In one or more embodiments, spectrographic sensors, chemical sensors, optical sensors, capacitors, other types of sensors, or any combination thereof may be used to determine the cut or composition of the fluid mixture.

In conjunction with the systems, methods, and devices described above with respect to FIGS. 1-10, a flowmeter 200 is described that may include a valve 150 with a fluid flow path that changes in shape, cross-sectional area, and direction from inlet 212 to outlet 226. The changes in the shape, cross-sectional area, and direction may facilitate release of entrained gas from the fluid mixture. The valve 150 may include a check disk 230 configured to move in response to pressure from the fluid mixture and optionally from released gas from the fluid mixture. The flowmeter 200 may include a piston 236 coupled to the check disk 230 and a piston housing 204 configured to control a movement path of the piston 236 and indirectly of the check disk 230. In one or more embodiments, a lower piston cylinder 246 and an upper piston cylinder 256 may constrain lateral movement of the piston 236 to prevent lateral displacement of the check disk 230, which might otherwise cause the check disk 230 to get stuck.

The flowmeter 200 may include a sensor housing 208 including a plurality of sensors configured to determine flow characteristics of the fluid mixture based on a position of the piston 236, a frequency of movement of the piston 236, a slope of the position of the piston 236 over time, a dielectric of the fluid mixture, a pressure measurement, other data, or any combination thereof. In one or more embodiments, the piston 236 may define a dynamic target tube 248 including a lumen 250 into which a portion of a sensor body 252 may fit. Movement of the piston 236 may cause the extent of the sensor body 252 within the lumen 250 to vary, which variation may be detected by the sensor 250.

In one or more embodiments, the check disk 230, a valve flange 244, a separator 247, the piston housing 206, the lower piston cylinder 246, and the upper piston cylinder 256 may provide a fluid flow path from the inlet chamber 222 into the piston housing 206 and back to the inlet chamber 222. This fluid flow path may enable exposure of the sensors to the fluid mixture to maintain a consistent temperature across the sensors 152. Further, the fluid flow path may reduce piston pressure within the piston cylinders 246 and 256 so that the piston 236 does not become stuck.

In one or more embodiments, the shape and size of the inlet chamber 216, the directional, shape, and cross-sectional area changes provided by an inlet transition 214 that extends between an inlet 212 and the inlet chamber, and one or more of the orientation or the overhang 602 may facilitate release of the entrained gas from the fluid mixture. The released gas may build up until the gas pressure can move the check disk 230 beyond its current displacement and then the released gas escapes rapidly through the opening 220 and around the check disk 230.

This disclosure may be further understood in light of the following examples.

Example 1: A flowmeter includes a valve and at least one housing; the valve includes a fluid flow path including a first portion, a second portion, and a valve seat between the first portion and the second portion, the valve seat including an opening defining a narrowing constriction having a cross-sectional area that is less than a cross-sectional area of at least one of the first portion or the second portion of the fluid flow path; a check disk biased against the valve seat and configured to move in response to fluid pressure of the fluid mixture, wherein a position of the check disk relative to the valve seat defines a variable constriction having a range from zero to the cross-sectional area of the opening through the valve seat; the least one housing is coupled to the valve and defining a fluid path from the second portion of the fluid flow path through at least a portion of the at least one housing and back to the second portion of the fluid flow path, the at least one housing including: a first position sensor within the fluid path and configured to determine position data associated with the check disk relative to the valve seat; and a second position sensor within the fluid path and configured to provide static position reference data; and circuitry configured to calibrate the position data using the static position reference data and to determine flow data corresponding to multiple phases of the fluid mixture based on the calibrated position data over time.

Example 2: The flowmeter of Example 1, where the flow data includes a first flow volume of a gas and one or more second flow volumes of incompressible components of the fluid mixture.

Example 3: The flow meter of any of Examples 1 or 2, where the circuitry is configured to determine a first cut of oil and a second cut of water based on electrical signals of one or more of the first position sensor or the second position sensor.

Example 4: The flow meter of any of Examples 1-3, where at least one housing further includes: a temperature sensor within the fluid path and configured to generate temperature data related to the fluid mixture; and a pressure sensor within the fluid path defined by the at least one housing, the pressure sensor configured to determine pressure data associated with the fluid mixture ; and wherein the circuitry is configured to determine a fluid density of the fluid mixture based on the temperature data and the pressure data.

Example 5: The flowmeter of Example 4, where the circuity is configured to determine one or more second flow volumes of incompressible components of the fluid mixture based on the pressure data, the temperature data, and the position data over time, and electrical signals of one or more of the first position sensor or the second position sensor.

Example 6: The flowmeter of any of Examples 1-5, where the circuitry is configured to determine the first flow volume of the gas based on one or more of a frequency determined from the position data, one or more displacements determined from the position data, or one or more rates of change determined from the position data.

Example 7: The flowmeter of any of Examples 1-6, where the cross-sectional area (Aₛₑₐₜ) of the narrowing constriction of the valve seat is defined as Aₛₑₐₜ=πR², where R represents a radius of an opening through the valve seat; and the cross-sectional area (A_{variable}) of the variable constriction provided by the check disk relative to a surface of the valve seat is defined as A_{variable}=2πRH, where R is the radius of the opening through the valve seat, and h is a displacement of the check disk relative to the surface of the valve seat.

Example 8: The flowmeter of any of Examples 1-7, where the circuitry is configured to determine the first flow volume of the gas associated with the released gas based on the position data.

Example 9: The flowmeter of Example 7, where the circuitry determines the gas flow volume based on a frequency of changes in the position data.

Example 10: The flowmeter of any of Examples 1-9, where the circuitry is configured to determine a cut of the fluid mixture based on a change in a strength of an electric signal associated with at least one of the plurality of sensors.

Example 11: The flowmeter of any of Examples 1-10, where the circuitry comprises a network interface configured to communicate the flow data to a control system through a communications network.

Example 12: A flowmeter includes: a valve defining a fluid flow path including: an inlet portion; an outlet portion; and a valve seat including an opening configured to couple the inlet portion to the outlet portion, the opening defining a narrowing constriction relative to one of the inlet portion or the outlet portion; and a check disk within the outlet portion and biased against the valve seat and configured to move in response to the fluid mixture; and a housing coupled to the valve and defining a fluid path extending from the outlet portion through a portion of the housing and back to the outlet portion, the housing including: a first position sensor within the fluid path and configured to determine position data associated with the check disk relative to the valve seat; and a temperature sensor within the fluid path and configured to generate temperature data related to the fluid mixture; and a pressure sensor within the fluid path and configured to determine pressure data associated with the fluid mixture ; and circuitry configured to determine a fluid density of the fluid mixture based on the temperature data and the pressure data and to determine flow data corresponding to multiple phases of the fluid mixture based on the position data and the fluid density.

Example 13: The flowmeter of Example 12, where the housing further includes: a second position sensor within the fluid path and configured to provide static position reference data; and wherein the circuitry is configured to calibrate the position data using the static position reference data; and wherein the flow data is determined based on the calibrated position data over time.

Example 14: The flowmeter of any of Examples 12-13, where the flow data includes a first flow volume of a gas and one or more second flow volumes of incompressible components of the fluid mixture.

Example 15: The flowmeter of any of Examples 12-14, where the circuitry is configured to determine a first cut of oil and a second cut of water based on electrical signals of one or more of the first position sensor or the second position sensor.

Example 16: The flowmeter of Example 15, where the circuity is configured to determine one or more second flow volumes of incompressible components of the fluid mixture based on the pressure data, the temperature data, the position data over time, and electrical signals of one or more of the first position sensor or the second position sensor.

Example 17: The flowmeter of any of Examples 12-16, where the circuitry is configured to determine the first flow volume of the gas based on one or more of a frequency determined from the position data, one or more displacements determined from the position data, or one or more rates of change determined from the position data.

Example 18: The flowmeter of any of Examples 12-17, where: the cross-sectional area (Aₛₑₐₜ) of the narrowing constriction of the valve seat is defined as Aₛₑₐₜ=πR², where R represents a radius of an opening through the valve seat; and the cross-sectional area (A_{variable}) of the variable constriction provided by the check disk relative to a surface of the valve seat is defined as A_{variable}=2πRH, where R is the radius of the opening through the valve seat, and h is a displacement of the check disk relative to the surface of the valve seat.

Example 19: The flowmeter of any of Examples 12-18, where the circuitry is configured to determine the first flow volume of a gas of the fluid mixture based on a frequency of changes in the position data.

Example 20: The flowmeter of any of Example 12-19, wherein the circuitry comprises a network interface configured to communicate the flow data to a control system through a communications network.

Although the present invention has been described with reference to preferred embodiments, workers skilled in the art will recognize that changes may be made in form and detail without departing from the scope of the invention.

What is claimed is:

1. A flowmeter comprising:
a valve comprising:
a fluid flow path including a first portion, a second portion, and a valve seat between the first portion and the second portion, the valve seat including an opening defining a narrowing constriction having a cross-sectional area that is less than a cross-sectional area of at least one of the first portion or the second portion of the fluid flow path;
a check disk biased against the valve seat and configured to move in response to fluid pressure of the fluid mixture, wherein a position of the check disk relative to the valve seat defines a variable constriction having a range from zero to the cross-sectional area of the opening through the valve seat;
and
at least one housing coupled to the valve and defining a fluid path from the second portion of the fluid flow path through at least a portion of the at least one housing and back to the second portion of the fluid flow path, the at least one housing including:
a first position sensor within the fluid path and configured to determine position data associated with the check disk relative to the valve seat; and
a second position sensor within the fluid path and configured to provide static position reference data; and
circuitry configured to calibrate the position data using the static position reference data and to determine flow data corresponding to multiple phases of the fluid mixture based on the calibrated position data over time.

2. The flowmeter of claim 1, wherein the flow data includes a first flow volume of a gas and one or more second flow volumes of incompressible components of the fluid mixture.

3. The flow meter of claim 1, wherein the circuitry is configured to determine a first cut of oil and a second cut of water based on electrical signals of one or more of the first position sensor or the second position sensor.

4. The flow meter of claim 1, wherein at least one housing further comprises:
a temperature sensor within the fluid path and configured to generate temperature data related to the fluid mixture; and
a pressure sensor within the fluid path defined by the at least one housing, the pressure sensor configured to determine pressure data associated with the fluid mixture ;
and
wherein the circuitry is configured to determine a fluid density of the fluid mixture based on the temperature data and the pressure data.

5. The flowmeter of claim 4, wherein the circuity is configured to determine one or more second flow volumes of incompressible components of the fluid mixture based on the pressure data, the temperature data, and the position data over time, and electrical signals of one or more of the first position sensor or the second position sensor.

6. The flowmeter of claim 1, wherein the circuitry is configured to determine the first flow volume of the gas based on one or more of a frequency determined from the position data, one or more displacements determined from the position data, or one or more rates of change determined from the position data.

7. The flowmeter of claim 1, wherein:
the cross-sectional area (Aₛₑₐₜ) of the narrowing constriction of the valve seat is defined as Aₛₑₐₜ=πR², where R represents a radius of an opening through the valve seat; and
the cross-sectional area (A_{variable}) of the variable constriction provided by the check disk relative to a surface of the valve seat is defined as A_{variable}=2πRH, where R is the radius of the opening through the valve seat, and h is a displacement of the check disk relative to the surface of the valve seat.

8. The flowmeter of claim 1, wherein the circuitry is configured to determine the first flow volume of the gas associated with the released gas based on the position data.

9. The flowmeter of claim 7, wherein the circuitry determines the gas flow volume based on a frequency of changes in the position data.

10. The flowmeter of claim 1, wherein the circuitry is configured to determine a cut of the fluid mixture based on a change in a strength of an electric signal associated with at least one of the plurality of sensors.

11. The flowmeter of claim 1, wherein the circuitry comprises a network interface configured to communicate the flow data to a control system through a communications network.

12. A flowmeter comprising:
a valve defining a fluid flow path including:
an inlet portion;
an outlet portion; and
a valve seat including an opening configured to couple the inlet portion to the outlet portion, the opening defining a narrowing constriction relative to one of the inlet portion or the outlet portion; and
a check disk within the outlet portion and biased against the valve seat and configured to move in response to the fluid mixture; and
a housing coupled to the valve and defining a fluid path extending from the outlet portion through a portion of the housing and back to the outlet portion, the housing including:
a first position sensor within the fluid path and configured to determine position data associated with the check disk relative to the valve seat; and
a temperature sensor within the fluid path and configured to generate temperature data related to the fluid mixture; and
a pressure sensor within the fluid path and configured to determine pressure data associated with the fluid mixture ; and
circuitry configured to determine a fluid density of the fluid mixture based on the temperature data and the pressure data and to determine flow data corresponding to multiple phases of the fluid mixture based on the position data and the fluid density.

13. The flowmeter of claim 12, wherein the housing further comprises:
a second position sensor within the fluid path and configured to provide static position reference data; and
wherein the circuitry is configured to calibrate the position data using the static position reference data; and
wherein the flow data is determined based on the calibrated position data over time.

14. The flowmeter of claim 12, wherein the flow data includes a first flow volume of a gas and one or more second flow volumes of incompressible components of the fluid mixture.

15. The flowmeter of claim 12, wherein the circuitry is configured to determine a first cut of oil and a second cut of water based on electrical signals of one or more of the first position sensor or the second position sensor.

16. The flowmeter of claim 15, wherein the circuity is configured to determine one or more second flow volumes of incompressible components of the fluid mixture based on the pressure data, the temperature data, and the position data over time, and electrical signals of one or more of the first position sensor or the second position sensor.

17. The flowmeter of claim 12, wherein the circuitry is configured to determine the first flow volume of the gas based on one or more of a frequency determined from the position data, one or more displacements determined from the position data, or one or more rates of change determined from the position data.

18. The flowmeter of claim 12, wherein:
the cross-sectional area (Aₛₑₐₜ) of the narrowing constriction of the valve seat is defined as Aₛₑₐₜ=πR², where R represents a radius of an opening through the valve seat; and
the cross-sectional area (A_{variable}) of the variable constriction provided by the check disk relative to a surface of the valve seat is defined as A_{variable}=2πRH, where R is the radius of the opening through the valve seat, and h is a displacement of the check disk relative to the surface of the valve seat.

19. The flowmeter of claim 12, wherein the circuitry is configured to determine the first flow volume of a gas of the fluid mixture based on a frequency of changes in the position data.

20. The flowmeter of claim 12, wherein the circuitry comprises a network interface configured to communicate the flow data to a control system through a communications network.
